(19) United States
(12) Patent Application Publication
(10) Pub. No.: US 2010/0088674 A1
(43) Pub. Date: Apr. 8, 2010

(54) SYSTEM AND METHOD FOR RECOGNIZING STRUCTURE IN TEXT

(75) Inventors: Giovanni Moises Della-Libera, Seattle, WA (US); Clemens Alden Szyperski, Redmond, WA (US); Steven Edward Lucco, Bellevue, WA (US); Douglas Allen Walter, Redmond, WA (US); John Braden Keiser, Renton, WA (US)

Correspondence Address: TUROCY & WATSON, LLP, 127 Public Square, 57th Floor, Key Tower, CLEVELAND, OH, 44114, US

(73) Assignee: MICROSOFT CORPORATION, Redmond, WA (US)

(21) Appl. No.: 12/415,553

(22) Filed: Mar. 31, 2009

Related U.S. Application Data
(60) Provisional application No. 61/103,156, filed on Oct. 6, 2008.

(51) Int. Cl. G06F 9/44; G06F 9/45

(52) U.S. Cl. 717/114; 717/142

(57) ABSTRACT

A method, system, and computer product for processing information embedded in a text file with a grammar programming language is provided. A text file is parsed according to a set of rules and candidate textual shapes corresponding to potential interpretations of the text file are provided by compiling a script. An output is provided, which may include either a processed value corresponding to a particular textual shape, or a textual representation of the text file that includes generic data structures that facilitate providing any of the candidate textual shapes, where the generic data structures are a function of the set of rules.

### CROSS-REFERENCE TO RELATED APPLICATION

This application claims the benefit of U.S. Provisional Patent application Ser. No. 61/103,156 entitled “SYSTEM AND METHOD FOR RECOGNIZING STRUCTURE IN TEXT,” which was filed Oct. 6, 2008. The entirety of the aforementioned application is herein incorporated by reference.

### TECHNICAL FIELD

The subject disclosure generally relates to recognizing structure in text, and more particularly to a grammar programming language for recognizing structure in text.

### BACKGROUND

Text is often the most natural way to represent information for presentation and editing by people. However, the ability to extract that information for use by software has been an arcane art practiced only by the most advanced developers. The success of XML is evidence that there is significant demand for using text to represent information—this evidence is even more compelling considering the relatively poor readability of XML syntax and the decade-long challenge to make XML-based information easily accessible to programs and stores. The emergence of simpler technologies like JSON and the growing use of meta-programming facilities in Ruby to build textual domain specific languages (DSLs) such as Ruby on Rails or Rake speak to the desire for natural textual representations of information. However, even these technologies limit the expressiveness of the representation by relying on fixed formats to encode all information uniformly, resulting in text that has very few visual cues from the problem domain (much like XML).

The above-described deficiencies of are merely intended to provide an overview of some of the problems of conventional systems, and are not intended to be exhaustive. Other problems with conventional systems and corresponding benefits of the various non-limiting embodiments described herein may become further apparent upon review of the following description.

### SUMMARY

A simplified summary is provided herein to help enable a basic or general understanding of various aspects of exemplary, non-limiting embodiments that follow in the more detailed description and the accompanying drawings. However, this summary is not intended to represent an extensive or exhaustive overview. Instead, the sole purpose of this summary is to present some concepts related to some exemplary non-limiting embodiments in a simplified form as a prelude to the more detailed description of the various embodiments that follow.

Embodiments of a method, system, and computer product for processing information embedded in a text file with a grammar programming language are described. In various non-limiting embodiments, the method includes receiving a text file having a plurality of input values. Within such embodiment, each of the input values are parsed according to a set of rules. The method also includes compiling a script so as to produce a set of candidate textual shapes such that each of the candidate textual shapes correspond to a potential interpretation of the input values. And finally, the method concludes with providing an output, which may include either a processed value or a textual representation of the text file. Here, the processed value corresponds to a particular textual shape, where the particular textual shape is selected from the candidate textual shapes, and the textual representation includes generic data structures that facilitate providing any of the candidate textual shapes, where the generic data structures are a function of the set of rules.

In another embodiment, a computer-readable storage medium is provided. Within such embodiment, five modules including instructions for executing various tasks are provided. In the first module, instructions are provided for receiving a text file as an input, whereas the second module includes instructions for providing a library of constructs for interpreting a textual shape of the text file. The third module, includes instructions for providing a script editor configured to facilitate generating a script of a grammar programming language in which the script includes constructs from the constructs library. In the fourth module, instructions are provided for compiling the script against the text file so as to generate candidate textual shapes in which each of the candidate textual shapes corresponds to a potential interpretation of the text file. And finally, the fifth module includes instructions for providing an output, which may include either a processed value or a textual representation of the text file. Here again, the processed value corresponds to a particular textual shape, where the particular textual shape is selected from the candidate textual shapes, and the textual representation includes generic data structures that facilitate providing any of the candidate textual shapes, where the generic data structures are a function of the set of rules.

In yet another embodiment, a system for processing information embedded in a text file with a grammar programming language is provided. The system includes means for receiving a text file having a plurality of input values. Within such embodiment, means for parsing each of the input values according to a set of rules is provided. The system also includes a means for identifying a syntactical ambiguity, as well as a means for identifying a token ambiguity. The system further includes means for prioritizing a set of candidate textual shapes in which at least one candidate resolution to the syntactical ambiguity is included in the candidate textual shapes. Also included are a means for resolving the token ambiguity as well as means for compiling a script so as to produce the candidate textual shapes such that each of the candidate textual shapes correspond to a potential interpretation of the input values. And finally, the system includes a means for providing an output, which may include either a processed value or a textual representation of the text file. Here again, the processed value corresponds to a particular textual shape, where the particular textual shape is selected from the candidate textual shapes, and the textual representation includes generic data structures that facilitate providing any of the candidate textual shapes, where the generic data structures are a function of the set of rules.

These and other embodiments are described in more detail below.

### BRIEF DESCRIPTION OF THE DRAWINGS

Various non-limiting embodiments are further described with reference to the accompanying drawings in which:

FIG. 1 is a diagram illustrating an exemplary process that utilizes a grammar programming language according to an embodiment;

FIG. 2 is a block diagram illustrating an exemplary system for processing information embedded in a text file with a grammar programming language according to an embodiment;

FIG. 3 is an illustration of an exemplary coupling of electrical components that effectuate processing information embedded in a text file with a grammar programming language according to an embodiment;

FIG. 4 is a block diagram illustrating exemplary modules of a computer product configured to facilitate processing information embedded in a text file with a grammar programming language according to an embodiment;

FIG. 5 is a flow diagram illustrating an exemplary process for resolving a syntactical ambiguity via a grammar programming language according to an embodiment;

FIG. 6 is a flow diagram illustrating an exemplary process for resolving a token ambiguity via a grammar programming language according to an embodiment;

FIG. 7 is a flow diagram illustrating an exemplary process for textually representing a nested programming language via a grammar programming language according to an embodiment;

FIG. 8 is a flow diagram illustrating an exemplary process for providing a rule parameter in a grammar programming language according to an embodiment;

FIG. 9 is a flow diagram illustrating an exemplary process for incrementally parsing a program via a grammar programming language according to an embodiment;

FIG. 10 is a flow diagram illustrating an exemplary process for interleaving whitespace via a grammar programming language according to an embodiment;

FIG. 11 is a block diagram representing exemplary non-limiting networked environments in which various embodiments described herein can be implemented; and

FIG. 12 is a block diagram representing an exemplary non-limiting computing system or operating environment in which one or more aspects of various embodiments described herein can be implemented.

### DETAILED DESCRIPTION

Various embodiments are now described with reference to the drawings, wherein like reference numerals are used to refer to like elements throughout. In the following description, for purposes of explanation, numerous specific details are set forth in order to provide a thorough understanding of one or more embodiments. It may be evident, however, that such embodiment(s) may be practiced without these specific details. In other instances, well-known structures and devices are shown in block diagram form in order to facilitate describing one or more embodiments.

In an aspect, a novel grammar programming language (hereinafter sometimes referred to as “M_{g}”) is provided. As will be discussed in more detail below, particular embodiments described herein enable information to be represented in a textual form that is tuned for both the problem domain and the target audience.

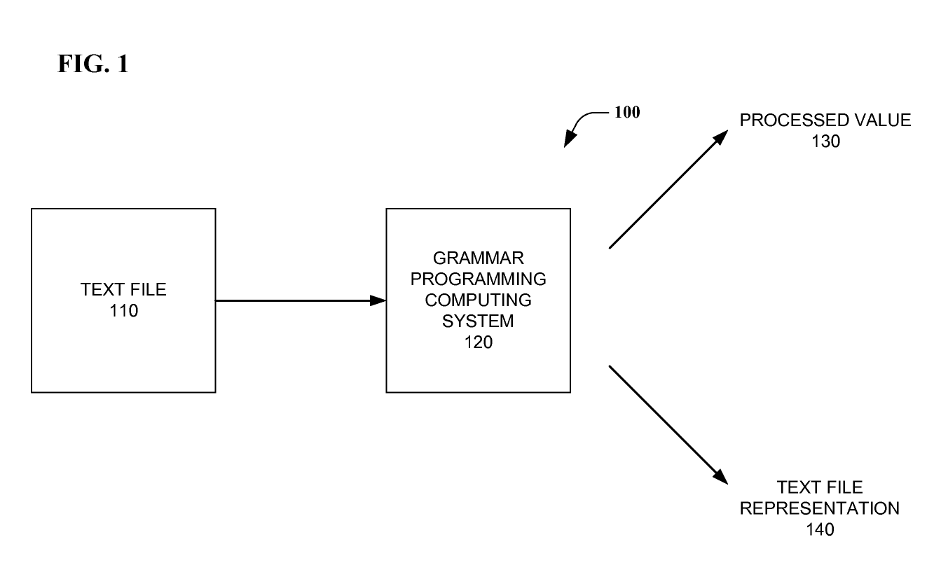

Referring first to FIG. 1, an exemplary process that utilizes aspects of M_{g} is provided. As illustrated, process 100 includes a text file 110 being input to a grammar programming computing system 120. In an aspect, computing system 120 is configured to run scripts authored in M_{g} against any type of text file so as to ascertain the textual shape of the file, which may include the input syntax as well as the structure and contents of the underlying information. Moreover, the M_{g} programming language provides simple constructs for describing the shape of a textual language, which enables M_{g} to act as both a schema language and a transformation language. For instance, when used as a schema language, M_{g} scripts may be used to analyze the textual shape of text file 110 to validate that the textual input conforms to a given programming language such validation may be output as processed value 130.

When used as a transformation language, however, M_{g} scripts may be used to project the textual input of text file 110 into generic data structures that are amenable to further processing or storage such as text file representation 140. Indeed, in an embodiment, data that results from M_{g} processing is compatible with M_{g}'s sister language, The “Oslo” Modeling Language, “M”, which provides a SQL-compatible schema and query language that can be used to further process the underlying information of text file 110. Here, it should be noted that, although M_{g} is particularly useful within the context of parsing computer program text, text file 110 may include any file that includes a plurality of characters.

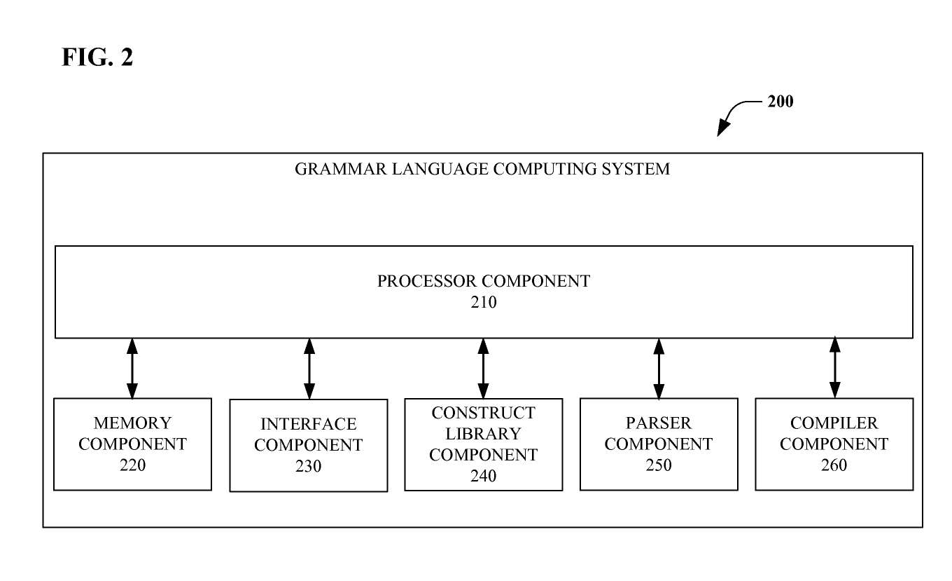

Referring next to FIG. 2, a block diagram illustrating components of an exemplary grammar language computing system 200 is provided. As shown, such a system 200 may include a processor 210 coupled to each of a memory component 220, interface component 230, construct library component 240, parser component 250, and compiler component 260.

In one aspect, processor component 210 is configured to execute computer-readable instructions related to performing any of a plurality of functions. Such functions may include controlling any of memory component 220, interface component 230, construct library component 240, parser component 250, and/or compiler component 260. Other functions performed by processor component 210 may include analyzing information and/or generating information that can be utilized by any of memory component 220, interface component 230, construct library component 240, parser component 250, and/or compiler component 260. Here, it should also be noted that processor component 210 can be a single processor or a plurality of processors.

In another aspect, memory component 220 is coupled to processor component 210 and configured to store computer-readable instructions executed by processor component 210. Memory component 220 may also be configured to store any of a plurality of other types of data including, for instance, queued text files to be analyzed, compile-time artifacts, etc., as well as data generated by any of interface component 230, construct library component 240, parser component 250, and/or compiler component 260. Memory component 220 can be configured in a number of different configurations, including as random access memory, battery-backed memory, hard disk, magnetic tape, etc. Various features can also be implemented upon memory component 220, such as compression and automatic back up (e.g., use of a Redundant Array of Independent Drives configuration).

As shown, computing system 200 may also include interface component 230. In an embodiment, interface component 230 is coupled to processor component 210 and configured to interface computing system 200 with external entities. For instance, receiving component 630 may be configured to receive text files to be analyzed, as well as to provide a script editor tool for authoring M_{g} scripts. Interface component 230 may also be configured to display an output to a user, as well as to transmit the output to an external entity (e.g., via a network connection).

In another aspect, computing system 200 also includes construct library 240, as shown. Within such embodiment, construct library 240 includes a plurality of constructs that may be utilized to describe the shape of a textual language. Moreover, construct library 240 provides a user with a plurality of constructs that may be used to author M_{g} scripts designed to ascertain the particular textual shape of a text file. Such constructs may be utilized to enforce particular rules, including rules designed to resolve potential ambiguities encountered while parsing a text file. A more detailed discussion of various constructs provided in M_{g} is discussed later.

Computing system 200 may also include parser component 250. In an embodiment, parser component 250 is configured to parse through received text files according to a set of rules, which may include a set of default rules and/or a set of rules explicitly declared by a user. Specifically, parser component 250 is configured to ascertain the textual value of each character, either individually or in combination, so as to determine how such textual value should be represented.

In another aspect, computing system 200 also includes compiler component 260, as shown. In an embodiment, compiler component 260 is coupled to processor component 210 and configured to compile scripts generated by a user. Here, it should be noted that compiler 260 may be configured to compile any of a plurality of types of compile-time artifacts. For instance, in an aspect, a plurality of candidate textual shapes for a given text file might be compiled, wherein such candidate textual shapes correspond to potential interpretations of parsed text values.

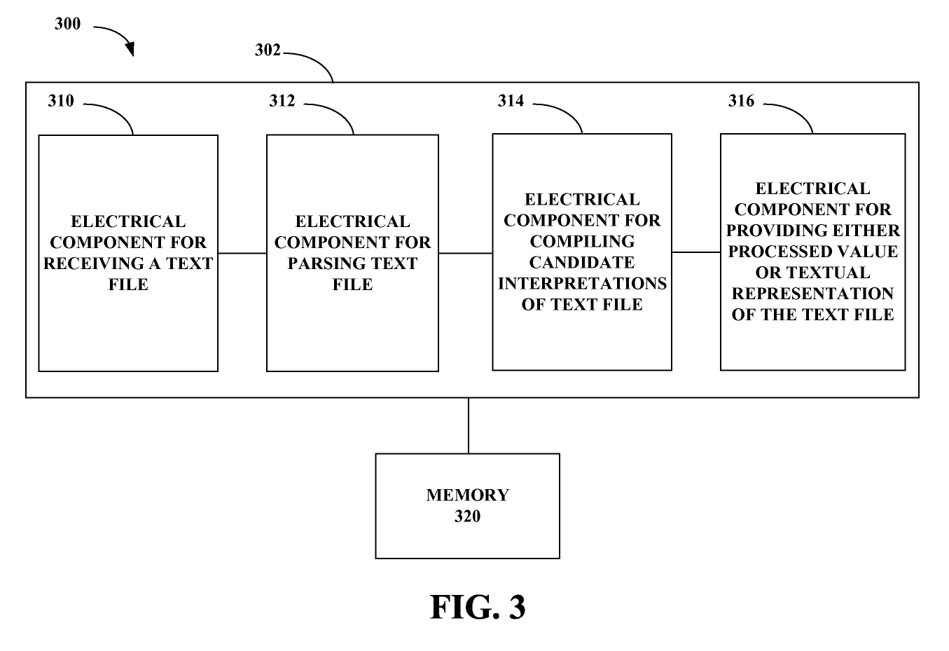

Turning to FIG. 3, illustrated is a system 300 that enables processing information embedded in a text file with a grammar programming language. System 300 can reside within a computer, for instance. As depicted, system 300 includes functional blocks that can represent functions implemented by a processor, software, or combination thereof (e.g., firmware). System 300 includes a logical grouping 302 of electrical components that can act in conjunction. As illustrated, logical grouping 302 can include an electrical component for receiving a text file having a plurality of input values 310. Further, logical grouping 302 can include an electrical component for parsing the input values according to a set of rules 312, and another electrical component compiling candidate textual shapes for the text file corresponding to potential interpretations of the parsed input values 314. And finally, logical grouping 302 can also include an electrical component for providing either a processed value corresponding to a particular textual shape and/or a textual representation of the text file 316. Additionally, system 300 can include a memory 320 that retains instructions for executing functions associated with electrical components 310, 312, 314, and 316. While shown as being external to memory 320, it is to be understood that electrical components 310, 312, 314, and 316 can exist within memory 320.

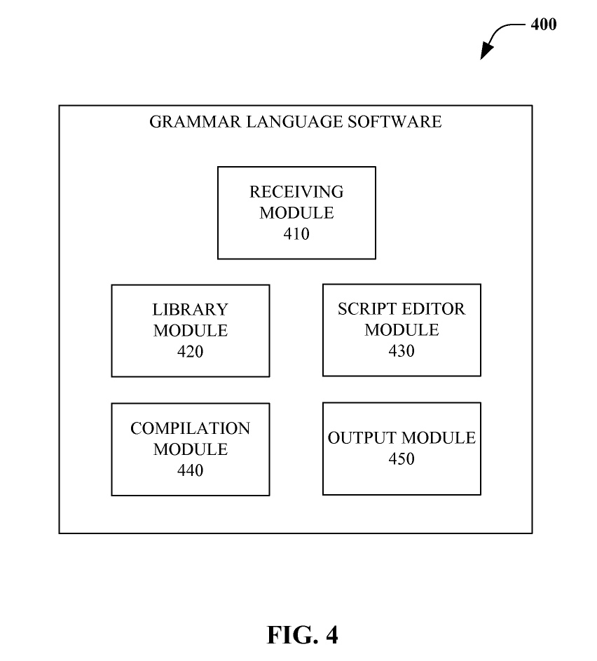

Referring next to FIG. 4, a block diagram of an exemplary computer program product that facilitates utilizing aspects of the disclosed grammar programming language is provided. As illustrated, computer product 400 comprises several programming modules including, receiving module 410, library module 420, script editor module 430, compilation module 440, and output module 450. Within such embodiment, each of receiving module 410, library module 420, script editor module 430, compilation module 440, and output module 450, collectively provide a software product that enable a user to author and execute scripts of a grammar programming language consistent with various novel aspects disclosed herein. For instance, receiving module may include code for receiving a text file, whereas library module 420 may include code linking a user to the aforementioned construct library. Similarly, script editor module 430 may include instructions for launching a script editor, compilation module 440 may include instructions for how to compile a script, and output module 450 may include output instructions.

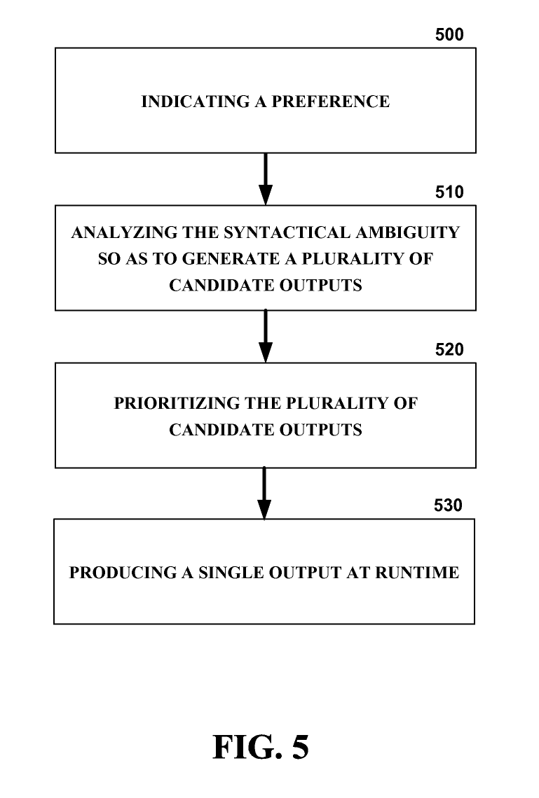

Referring next to FIGS. 5-10, several exemplary methodologies for utilizing novel aspects of the disclosed grammar programming language are provided. For instance, in FIG. 5, a flow diagram illustrating an exemplary process for resolving a syntactical ambiguity is provided. As illustrated, such process begins at step 500 where a preferential rule for resolving a particular syntactical ambiguity is indicated. Within such embodiment, the particular syntactical ambiguity is then analyzed across the entire rulespace at step 510, which includes an analysis of the ambiguity according to the preferred rule indictated at step 500, as well as a plurality of alternative rules. Moreover, the analysis at step 510 generates a plurality of candidate outputs for the ambiguity, which includes a preferred output corresponding to the preferred rule and a plurality of alternative outputs corresponding to the plurality of alternative rules. The process continues at step 520 where the plurality of candidate outputs are then prioritized. The process then concludes at step 530 where a single output is produced at runtime. Here, it should be noted that the single output that is produced depends on which rules have survived. For instance, if the preferred rule survives, the single output may be the preferred output. Otherwise, the single output may be selected from the plurality of alternative outputs as a function of the prioritization at step 520.

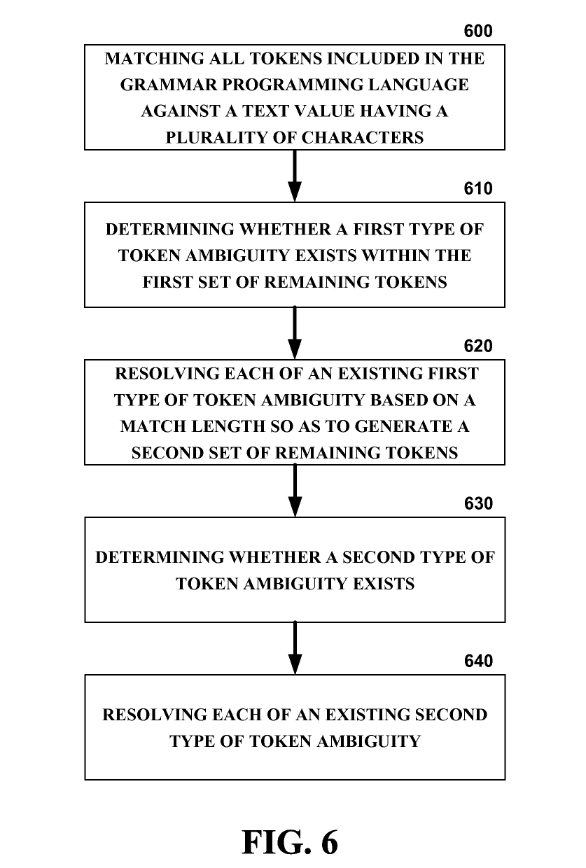

Referring next to FIG. 6, a flow diagram illustrating an exemplary process for resolving a token ambiguity via the disclosed grammar programming language is provided. As illustrated, such process begins at step 600 by matching all tokens included in the grammar programming language against a plurality of characters of a textual value. Within such embodiment, the matching step is performed sequentially on each of the plurality of characters so as to generate a first set of remaining tokens. The process continues at step 610 where a determination is made as to whether a first type of token ambiguity exists within the first set of remaining tokens. In an embodiment, such first type of token ambiguity exists if the first set of remaining tokens includes more than one token. At step 620, at attempt is made to resolve each of the first type of token ambiguities by selecting the token(s) having the largest match length so as to reduce the first set of remaining tokens to a second set of remaining tokens. The process continues at step 630 where a determination is made as to whether a second type of token ambiguity now exists. Here, the second type of token ambiguity may, for example, exist if each of the second set of remaining tokens have the same match length. If an ambiguity still exists at step 630, an attempt to resolve the ambiguity is then made at step 640 by determining whether one of the second set of remaining tokens is a token marked “final.” In an embodiment, if one of the remaining tokens is indeed a token marked “final,” the token marked final is selected. Otherwise, the each of the second set of remaining tokens retained and a new token is matched against the text value starting with a first character that has not already been matched.

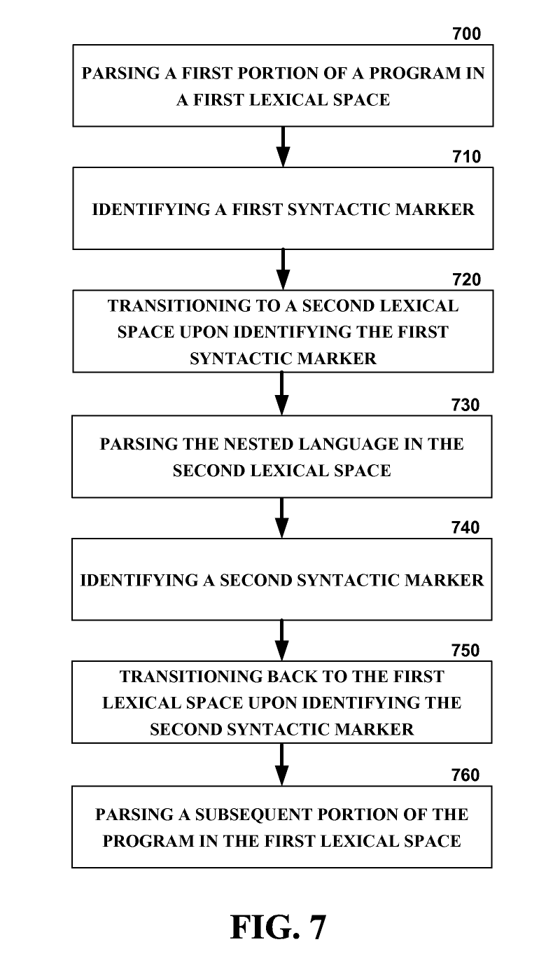

Referring next to FIG. 7, a flow diagram illustrating an exemplary process for textually representing a nested programming language is provided. Here, it should be appreciated that a call for representing a nested programming language may include utilizing a keyword (e.g., “nest”) in which the keyword invokes a syntactically driven algorithm within the parsing context for transitioning to a different lexical space upon identifying a nested language. As illustrated, such process begins at step 700 where a first portion of a program is parsed in a first lexical space. The process continues to parse the program in the first lexical space until a first syntactical marker (e.g., a token) is identified at step 710. Within such embodiment, the first syntactic marker demarcates the beginning of a nested language. Upon identifying the first syntactic marker, the process then transitions to a second lexical space at step 720. At step 730, the nested language is then parsed in this second lexical space. The nested language continues to be parsed in this second lexical space until a second syntactic marker demarcating the end of the nested language is identified at step 740. Once this second syntactic marker is identified, the process continues with a transition back to the first lexical space at step 750. The subsequent portion of the program is then parsed in the first lexical space at step 760.

In another embodiment, lexical ambiguities are resolved using an ambiguity resolution mechanism provided by the parser. Within such embodiment, each time the parser asks the lexer for a token, the parser provides the lexer with an indication of the last token received and which token patterns it is expecting at that time, wherein the lexer restricts the token patterns it considers to that set. The lexer then starts at the next character after the previous returned token and tries to apply each pattern to the subsequent input “greedily.” Each pattern that matches then produces a token at the longest length that the pattern supports. This mechanism may be referred to as a “local max-munch” mechanism because each pattern “max-munches” separately, instead of the whole lexer “max-munching” for the union of all acceptable patterns. For instance, if two or more tokens of different lengths are returned, then the parser will spawn different “threads” of execution for each possible token and now the threads are no longer synchronized at the same character position but can now veer off. Exemplary M_{g} code for this mechanism may include:

Language Foo

{
Interleave WS = “ “+;
token Hello = “hello”;
token World = “world”;
token Dash = “-“;
token EverythingButDash = (\hat{ }”-“)+;
token EndHello World = ”$“;
token EndGobbler = “%”;
syntax Main = Hello World | Gobbler;
syntax Hello World = Hello World Dash EndHello World;
syntax Gobbler = EverythingButDash Dash EndGobbler;
}

This language operates in the following manner. Upon execution, the two alternatives of “Main” start consuming input, wherein the initial tokens allowed are “Hello” and “EverythingButDash.” Therefore, if “hello” is followed by a whitespace, the first tokens for both “Main” alternatives are satisfied. On the “HelloWorld” path, a “World” token (or interleaves) is expected, whereas a “Dash” token (or interleaves) is expected on the “Gobbler” path. If “world” is seen, the text is consumed, wherein a “Dash” token (or interleaves) is now expected by both the “HelloWorld” path and the “Gobbler” path. Once a “Dash” token is seen, only an “EndHelloWorld” token or an “EndGobbler” token is subsequently expected. Based on whether an “EndHelloWorld” or “EndGobbler” token is seen, one or the other syntax is uniquely matched. As a result, a token like “EverythingButDash” may be defined without overwhelming all lexing (i.e., it is only considered when it is expected as a parse state).

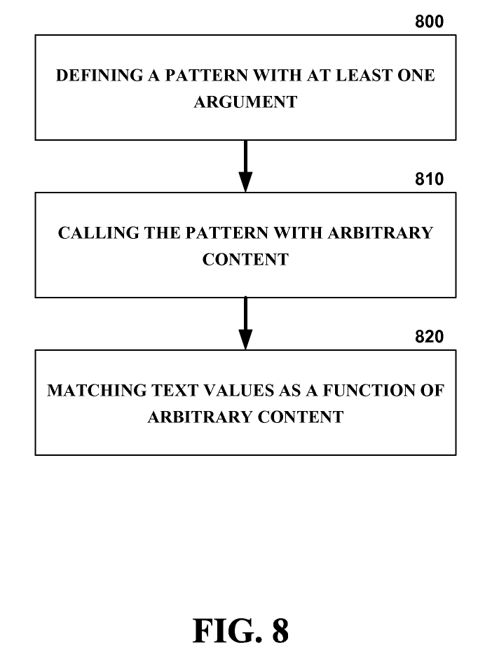

Referring next to FIG. 8, a flow diagram illustrating an exemplary process for providing a rule parameter in a grammar programming language is provided. Here, it should be noted that no currently available grammar language (e.g., LEX/YACC, ANTLR, etc.) allows for rule parameters to be implemented. As illustrated, such process begins at step 800 where a pattern having at least one argument is defined. The process continues at step 810 with the pattern being called in which the call includes substituting arbitrary content for each of the at least one arguments. The process then concludes at step 820 where text values are matched as a function of the arbitrary content included at step 810.

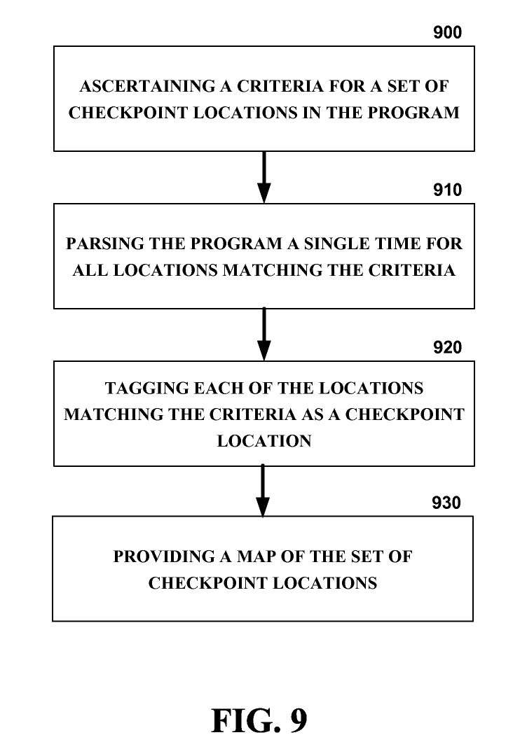

Referring next to FIG. 9, a flow diagram illustrating an exemplary process for incrementally parsing a program is provided. As illustrated, such process begins at step 900 where a criteria for a set of checkpoint locations in the program is ascertained. At step 910, the entire program is then parsed a single time for all locations matching the criteria ascertained at step 900. Each of the locations identified as matching the criteria at step 910 are then tagged as “checkpoint locations” at step 920. A map of the set of checkpoint locations is then provided at step 930. Within such embodiment, the map is configured to allow a user to parse smaller portions of the program in which these smaller portions either begin or end with a checkpoint location.

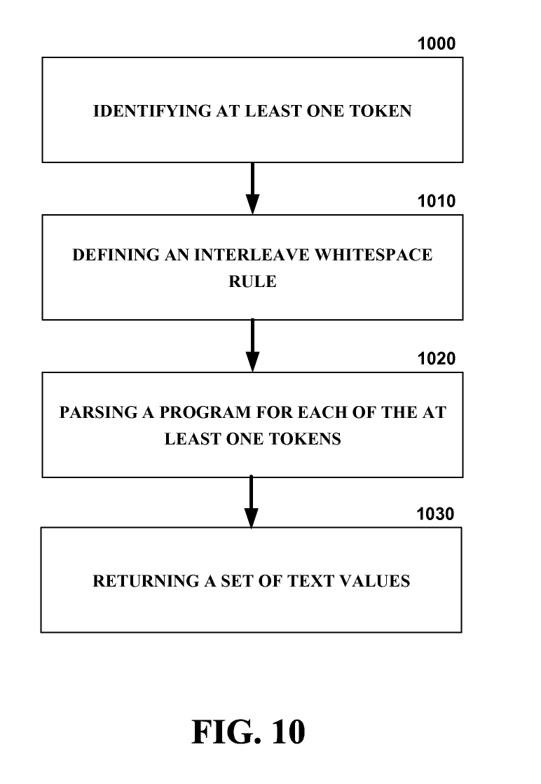

Referring next to FIG. 10, a flow diagram illustrating an exemplary process for interleaving whitespace is provided. As illustrated, such process begins at step 1000 where at least one token corresponding to a unique textual value is identified. At step 1010, the process continues with an interleave whitespace rule being defined. A desired program is then parsed for each of the at least one tokens at step 1020 in which the parsing step interleaves whitespace as a function of the interleave whitespace rule. The process then concludes at step 1030 where a set of textual values corresponding to each of the at least one tokens parsed out of the program is returned.

Exemplary Grammar Programming Language

As stated previously, an exemplary grammar language that is compatible with the scope and spirit of the disclosed subject matter is the M Grammar Language (M_{g}), which was developed by the assignee of the subject application. In addition to M_{g}, however, it is to be understood that other similar programming languages may be used, and that the utility of the disclosed subject matter is not limited to any single programming language. A brief description of M_{g} is provided below.

In an embodiment, an M_{g}-based language definition includes one or more named rules, each of which describe some part of the language. The following fragment is an example of a simple language definition:

language HelloLanguage {

syntax Main = “Hello, World”;

}

The language being specified is named HelloLanguage and it is described by one rule named Main. A language may contain more than one rule; the name Main is used to designate the initial rule that all input documents must match in order to be considered valid with respect to the language.

In one aspect, rules use patterns to describe the set of input values that the rule applies to. The Main rule above has only one pattern, “Hello, world” that describes exactly one legal input value:

Hello, World

If that input is fed to the M_{g} processor for this language, the processor will report that the input is valid. Any other input will cause the processor to report the input as invalid.

Typically, a rule will use multiple patterns to describe alternative input formats that are logically related. For example, consider the following language:

language PrimaryColors {

syntax Main = “Red” | “Green” | “Blue”;

}

Here, the Main rule has three patterns—input must conform to one of these patterns in order for the rule to apply. That means that the following is valid:

Red

as well as this:

Green

and this:

Blue

No other input values are valid in this language.

Most patterns in the wild are more expressive than those mentioned thus far—most patterns combine multiple terms. Every pattern consists of a sequence of one or more grammar terms, each of which describes a set of legal text values. Pattern matching has the effect of consuming the input as it sequentially matches the terms in the pattern. Each term in the pattern consumes zero or more initial characters of input—the remainder of the input is then matched against the next term in the pattern. If all of the terms in a pattern cannot be matched, the consumption is “undone” and the original input may be used as a candidate for matching against other patterns within the rule.

A pattern term can either specify a literal value (like in the first example) or the name of another rule. The following language definition matches the same input as the first example:

language HelloLanguage2 {

syntax Main = Prefix “, ” Suffix;
syntax Prefix = “Hello”;
syntax Suffix = “World”;

}

Like functions in a traditional programming language, rules can be declared to accept parameters. A parameterized rule declares one or more “holes” that must be specified to use the rule. The following is a parameterized rule:

syntax Greeting(salutation, separator)=salutation separator “World”;

To use a parameterized rule, actual rules may simply be provided as arguments to be substituted for the declared parameters:

syntax Main=Greeting(Prefix, “,”);

It should also be noted that a given rule name may be declared multiple times provided each declaration has a different number of parameters. That is, the following is legal:

syntax Greeting(salutation, sep, subject) = salutation sep subject;
syntax Greeting(salutation, sep) = salutation sep “World”;
syntax Greeting(sep) = “Hello” sep “World”;
syntax Greeting = “Hello” “, ” “World”;

The selection of which rule is used is determined based on the number of arguments present in the usage of the rule.

A pattern may indicate that a given term may match repeatedly using the standard Kleene operators (e.g., ?, *, and +). For example, consider this language:

language HelloLanguage3 {

syntax Main = Prefix “, ”? Suffix*;
syntax Prefix = “Hello”;
syntax Suffix = “World”;

}

This language considers the following all to be valid:

Hello
Hello,
Hello, World
Hello, WorldWorld
HelloWorldWorldWorld

Terms can be grouped using parentheses to indicate that a group of terms must be repeated:

language HelloLanguage3 {

syntax Main = Prefix (“, ” Suffix)+;
syntax Prefix = “Hello”;
syntax Suffix = “World”;

}

which considers the following to all be valid input:

Hello, World
Hello, World, World
Hello, World, World, World

The use of the +operator indicates that the group of terms must match at least once.

In the previous examples of the HelloLanguage, the pattern term for the comma separator included a trailing space. That trailing space was significant, as it allowed the input text to include a space after the comma:

Hello, World

More importantly, the pattern indicates that the space is not only allowed, but is required. That is, the following input is not valid:

Hello,World

Moreover, exactly one space is required, making this input invalid as well:

Hello, World

To allow any number of spaces to appear either before or after the comma, the rule could have been written like this:

syntax Main=‘Hello’“*‘,’”*‘World’;

While this is correct, in practice most languages have many places where secondary text such as whitespace or comments can be interleaved with constructs that are primary in the language. To simplify specifying such languages, a language may specify one or more named interleave patterns.

An interleave pattern specifies text streams that are not considered part of the primary flow of text. When processing input, the M_{g} processor implicitly injects interleave patterns between the terms in all syntax patterns. For example, consider this language:

language HelloLanguage {

syntax Main = “Hello” “,” “World”;
interleave Secondary = “ ”+;

}

This language now accepts any number of whitespace characters before or after the comma. That is,

| Hello,World | |
|---|---|
| Hello, World | |
| Hello , | World |

are all valid with respect to this language.

Interleave patterns simplify defining languages that have secondary text like whitespace and comments. However, many languages have constructs in which such interleaving needs to be suppressed. To specify that a given rule is not subject to interleave processing, the rule is written as a token rule rather than a syntax rule. Token rules identify the lowest level textual constructs in a language—by analogy token rules identify words and syntax rules identify sentences. Like syntax rules, token rules use patterns to identify sets of input values. Here's a simple token rule:

token BinaryValueToken=(“0”|“1”)+;

It identifies sequences of 0 and 1 characters much like this similar syntax rule:

syntax BinaryValueSyntax=(“0”|“1”)+;

A distinction between the two rules is that interleave patterns do not apply to token rules. That means that if the following interleave rule was in effect:

interleave IgnorableText=“ ”+;

then the following input value:

0 1011 1011

would be valid with respect to the BinaryValueSyntax rule but not with respect to the BinaryValueToken rule, as interleave patterns do not apply to token rules.

M_{g} also provides a shorthand notation for expressing alternatives that consist of a range of Unicode characters. For example, the following rule:

token AtoF=“A”|“B”|“C”|“D”|“E”|“F”;

can be rewritten using the range operator as follows:

token AtoF=“A”..“F”;

Ranges and alternation can compose to specify multiple non-contiguous ranges:

token AtoGnoD=“A”..“C”|“E”..“G”;

which is equivalent to this longhand form:

token AtoGnoD=“A”|“B”|“C”|“E”|“F”|“G”;

Note that the range operator only works with text literals that are exactly one character in length.

The patterns in token rules have a few additional features that are not valid in syntax rules. Specifically, token patterns can be negated to match anything not included in the set, by using the difference operator (−). The following example combines “difference” with “any.” “Any” matches any single character. The expression below matches any character that is not a vowel:

any−(‘A’|‘E’|‘I’|‘O’|‘U’)

Token rules are named and may be referred to by other rules:

token AorBorCorEorForG = (AorBorC | EorForG)+;
token AorBorC = ‘A’..‘C’;
token EorForG = ‘E’..‘G’;

Because token rules are processed before syntax rules, token rules cannot refer to syntax rules:

syntax X = “Hello”;
token HelloGoodbye = X | “Goodbye”; // illegal

However, syntax rules may refer to token rules:

token X= “Hello”;
syntax HelloGoodbye = X | “Goodbye”; // legal

The M_{g} processor treats all literals in syntax patterns as anonymous token rules. That means that the previous example is equivalent to the following:

token X= “Hello”;
token temp = “Goodbye”;
syntax HelloGoodbye = X | temp;

Operationally, the difference between token rules and syntax rules is when they are processed. Token rules are processed first against the raw character stream to produce a sequence of named tokens. The M_{g} processor then processes the language's syntax rules against the token stream to determine whether the input is valid and optionally to produce structured data as output. The next section describes how that output is formed.

M_{g} processing transforms text into structured data. The shape and content of that data is determined by the syntax rules of the language being processed. Each syntax rule consists of a set of productions, each of which consists of a pattern and an optional projection. Patterns were discussed previously and describe a set of legal character sequences that are valid input. Projections describe how the information represented by that input should be produced.

Each production is like a function from text to structured data. The primary way to write projections is to use a simple construction syntax that produces graph-structured data suitable for programs and stores. For example, consider this rule:

syntax Rock =

“Rock” => Item { Heavy { true }, Solid { true } } ;

This rule has one production that has a pattern that matches “Rock” and a projection that produces the following value (using a notation known as D graphs):

Item {

Heavy { true },
Solid { true }

}

Rules can contain more than one production in order to allow different input to produce very different output. Here's an example of a rule that contains three productions with very different projections:

syntax Contents

= “Rock” => Item { Heavy { true }, Solid { true } }
| “Water” => Item { Consumable { true }, Solid { false } }
| “Hamster” => Pet { Small { true }, Legs { 4 } } ;

When a rule with more than one production is processed, the input text is tested against all of the productions in the rule to determine whether the rule applies. If the input text matches the pattern from exactly one of the rule's productions, then the corresponding projection is used to produce the result. In this example, when presented with the input text “Hamster”, the rule would yield the following as a result:

Pet {

Small { true },
Legs { 4 }

}

To allow a syntax rule to match no matter what input it is presented with, a syntax rule may specify a production that uses the empty pattern, which will be selected if and only if none of the other productions in the rule match:

syntax Contents

= “Rock” => Item { Heavy { true }, Solid { true } }
| “Water” => Item { Consumable { true }, Solid { false } }
| “Hamster” => Pet { Small { true }, Legs { 4 } }
| empty => NoContent { } ;

When the production with the empty pattern is chosen, no input is consumed as part of the match.

To allow projections to use the input text that was used during pattern matching, pattern terms associate a variable name with individual pattern terms by prefixing the pattern with an identifier separated by a colon. These variable names are then made available to the projection. For example, consider this language:

language GradientLang {

syntax Main

= from:Color “, ” to:Color => Gradient { Start { from }, End
{ to } } ;

token Color

= “Red” | “Green” | “Blue”;

}

Given this input value:

Red, Blue

The M_{g} processor would produce this output:

Gradient {

Start { “Red” },
End { “Blue” }

}

Like all projection expressions discussed thus far, literal values may appear in the output graph. A set of literal types supported by M_{g} and a few examples follow:

Text literals—“ABC”, ‘ABC’

Integer literals—25, −34

Real literals—0.0, −5.0E15

Logical literals—true, false

Null literal—null

The projections discussed thus far all attach a label to each graph node in the output (e.g., Gradient, Start, etc.). The label is optional and can be omitted:

syntax Naked=t1:First t2:Second=>{t1,t2};

The label can be an arbitrary string—to allow labels to be escaped, one uses the id operator:

syntax Fancy=t1:First t2:Second=>id(“Label with Spaces!”){t1,t2};

The id operator works with either literal strings or with variables that are bound to input text:

syntax Fancy=name:Name t1:First t2:Second=>id(name){t1,t2};

Using id with variables allows the labeling of the output data to be driven dynamically from input text rather than statically defined in the language. This example works when the variable name is bound to a literal value. If the variable was bound to a structured node that was returned by another rule, that node's label can be accessed using the labelof operator:

syntax Fancier p:Point=>id(labelof(p)){1,2,3};

The labelof operator returns a string that can be used both in the id operator as well as a node value.

The projection expressions shown so far have no notion of order. That is, this projection expression:

A{X{100},Y{200}}

is semantically equivalent to this:

A{Y{200},X{100}}

and implementations of M_{g} are not required to preserve the order specified by the projection. To indicate that order is significant and must be preserved, brackets are used rather than braces. This means that this projection expression:

A[X{100},Y{200}]

is not semantically equivalent to this:

A[Y{200},X{100}]

The use of brackets is common when the sequential nature of information is important and positional access is desired in downstream processing.

Sometimes it is useful to splice the nodes of a value together into a single collection. The valuesof operator will return the values of a node (labeled or unlabeled) as top-level values that are then combinable with other values as values of new node.

syntax ListOfA

= a:A => [a]
| list:ListOfA “,” a:A => [ valuesof(list), a ];

Here, valuesof(list) returns the all the values of the list node, combinable with “a” to form a new list.

Productions that do not specify a projection get the default projection. For example, consider the following language that does not specify productions:

language GradientLanguage {

syntax Main = Gradient | Color;
syntax Gradient = from:Color “ on ” to:Color;
token Color = “Red” | “Green” | “Blue”;

}

When presented with the input “Blue on Green” the language processor returns the following output:

Main[Gradient[“Red”,“on”,“Green”]]]

These default semantics allows grammars to be authored rapidly while still yielding understandable output. However, in practice explicit projection expressions provide language designers complete control over the shape and contents of the output.

All of the examples shown so far have been “loose M_{g}” that is taken out of context. To write a legal M_{g} document, all source text must appear in the context of a module definition. A module defines a top-level namespace for any languages that are defined. Below is an exemplary module definition:

module Literals {

// declare a language
language Number {

syntax Main = (‘0’..‘9’)+;

}

}

In this example, the module defines one language named Literals.Number. Modules may refer to declarations in other modules by using an import directive to name the module containing the referenced declarations. For a declaration to be referenced by other modules, the declaration must be explicitly exported using an export directive. For example, consider the following module:

module MyModule {

import HerModule; // declares HerType
export MyLanguage1;
language MyLanguage1 {

syntax Main = HerLanguage.Options;

}
language MyLanguage2 {

syntax Main = “x”+;

}

}

Note that only MyLanguage1 is visible to other modules. This makes the following definition of HerModule legal:

module HerModule {

import MyModule; // declares MyLanguage1
export HerLanguage;
language HerLanguage {

syntax Options = ((‘a’..‘z’)+ (‘on’|‘off’))*;

}
language Private { }

}

As this example shows, modules may have circular dependencies.

Referring next to lexical structure, it should be noted that an M_{g} program may include one or more source files, known formally as compilation units. A compilation unit file is an ordered sequence of Unicode characters. Compilation units typically have a one-to-one correspondence with files in a file system, but this correspondence is not required. For maximal portability, it is recommended that files in a file system be encoded with the UTF-8 encoding.

Conceptually speaking, a program may be compiled using four steps. First a lexical analysis is made, which translates a stream of Unicode input characters into a stream of tokens. In an embodiment, lexical analysis evaluates and executes pre-processing directives. Second, a syntactic analysis is made, which translates the stream of tokens into an abstract syntax tree. Third, a semantic analysis is made, which resolves all symbols in the abstract syntax tree, type checks the structure and generates a semantic graph. And Fourth, a code generation step is included, which generates instructions from the semantic graph for some target runtime, producing an image. Further tools may link images and load them into a runtime.

Referring next to grammars, it should be noted that hereinafter the syntax of the M_{g} programming language will be presented using two grammars. A lexical grammar defines how Unicode characters are combined to form line terminators, white space, comments, tokens, and pre-processing directives, whereas a syntactic grammar defines how the tokens resulting from the lexical grammar are combined to form M_{g} programs.

In an embodiment, the lexical and syntactic grammars are presented using grammar productions. Each grammar production defines a non-terminal symbol and the possible expansions of that non-terminal symbol into sequences of non-terminal or terminal symbols. In grammar productions, NonTerminal symbols are shown in italic type, and terminal, symbols are shown in a fixed-width font. The first line of a grammar production is the name of the non-terminal symbol being defined, followed by a colon. Each successive indented line contains a possible expansion of the non-terminal given as a sequence of non-terminal or terminal symbols. For example, the production:

IdentifierVerbatim:

[ IdentifierVerbatimCharacters ]

defines an IdentifierVerbatim to consist of the token “[”, followed by IdentifierVerbatimCharacters, followed by the token “]”.

When there is more than one possible expansion of a non-terminal symbol, the alternatives are listed on separate lines. For example, the production:

DecimalDigits:

DecimalDigit
DecimalDigits DecimalDigit

defines DecimalDigits to either consist of a DecimalDigit or consist of DecimalDigits followed by a DecimalDigit. In other words, the definition is recursive and specifies that a decimal-digits list consists of one or more decimal digits.

A subscripted suffix “opt” may be used to indicate an optional symbol. The production:

DecimalLiteral:

IntegerLiteral . DecimalDigit DecimalDigitsₒₚₜ

is shorthand for:

DecimalLiteral:

IntegerLiteral . DecimalDigit
IntegerLiteral . DecimalDigit DecimalDigits

and defines a DecimalLiteral to consist of an IntegerLiteral followed by a ‘.’ a DecimalDigit and by optional DecimalDigits.

Alternatives are normally listed on separate lines, though in cases where there are many alternatives, the phrase “one of” may precede a list of expansions given on a single line. This is simply shorthand for listing each of the alternatives on a separate line. For example, the production:

Sign: one of

+ −

is shorthand for:

Sign:

+
−

Conversely, exclusions are designated with the phrase “none of”. For example, the production:

TextSimple: none of

”
\
NewLineCharacter

permits all characters except ‘″’, ‘\’, and new line characters.

Referring next to lexical grammar, it should be noted that the terminal symbols of the lexical grammar are the characters of the Unicode character set, and the lexical grammar specifies how characters are combined to form tokens, white space, and comments. Every source file in an M_{g} program must conform to the Input production of the lexical grammar.

Referring next to lexical grammar, it should be noted the terminal symbols of the syntactic grammar are the tokens defined by the lexical grammar, and the syntactic grammar specifies how tokens are combined to form M_{g} programs. Every source file in an M_{g} program must conform to the CompilationUnit production of the syntactic grammar.

Referring next to lexical analysis, the Input production defines the lexical structure of an M_{g} source file. Each source file in an M_{g} program must conform to this lexical grammar production.

Input:

InputSectionₒₚₜ

InputSection:

InputSectionPart
InputSection InputSectionPart

InputSectionPart:

InputElementsₒₚₜ NewLine

InputElements:

InputElement
InputElements InputElement

InputElement:

Whitespace
Comment
Token

Four basic elements make up the lexical structure of an M_{g} source file: line terminators, white space, comments, and tokens. Of these basic elements, only tokens are significant in the syntactic grammar of an M_{g} program.

The lexical processing of an M_{g} source file includes reducing the file into a sequence of tokens which becomes the input to the syntactic analysis. Line terminators, white space, and comments can serve to separate tokens, but otherwise these lexical elements have no impact on the syntactic structure of an M_{g} program. When several lexical grammar productions match a sequence of characters in a source file, the lexical processing always forms the longest possible lexical element. For example, the character sequence // is processed as the beginning of a single-line comment because that lexical element is longer than a single/token.

Line terminators divide the characters of an M_{g} source file into lines.

NewLine:

NewLineCharacter
U+000D U+000A

NewLineCharacter:

U+000A // Line Feed
U+000D // Carriage Return
U+0085 // Next Line
U+2028 // Line Separator
U+2029 // Paragraph Separator

For compatibility with source code editing tools that add end-of-file markers, and to enable a source file to be viewed as a sequence of properly terminated lines, the following transformations are applied, in order, to every compilation unit:

If the last character of the source file is a Control-Z character
(U+001A), this

character is deleted.

A carriage-return character (U+000D) is added to the end of the source
file if that

source file is non-empty and if the last character of the source
file is not a carriage return (U+000D), a line feed (U+000A),
a line separator (U+2028), or a paragraph separator (U+2029).

Referring next to comments, it should be appreciated that two forms of comments are supported: single-line comments and delimited comments. Single-line comments start with the characters // and extend to the end of the source line. Delimited comments start with the characters /* and end with the characters */. Delimited comments may span multiple lines.

Comment:

CommentDelimited
CommentLine

CommentDelimited:

/* CommentDelimitedContentsₒₚₜ */

CommentDelimitedContent:

* none of /

CommentDelimitedContents:

CommentDelimitedContent
CommentDelimitedContents CommentDelimitedContent

CommentLine:

// CommentLineContentsₒₚₜ

CommentLineContent: none of

NewLineCharacter

CommentLineContents:

CommentLineContent
CommentLineContents CommentLineContent

Comments do not nest. The character sequences /* and */ have no special meaning within a // comment, and the character sequences // and /* have no special meaning within a delimited comment.

Also, comments are not processed within text literals. For instance, the following example:

// This defines a
// Logical literal
//
syntax LogicalLiteral

= “true”
| “false” ;

shows three single-line comments, whereas the following example:

/* This defines a

Logical literal

*/
syntax LogicalLiteral

= “true“
| “false” ;

includes one delimited comment.

In an embodiment, whitespace is defined as any character with Unicode class Zs (which includes the space character) as well as the horizontal tab character, the vertical tab character, and the form feed character.

Whitespace:

WhitespaceCharacters

WhitespaceCharacter:

U+0009 // Horizontal Tab
U+000B // Vertical Tab
U+000C // Form Feed
U+0020 // Space
NewLineCharacter

WhitespaceCharacters:

WhitespaceCharacter
WhitespaceCharacters WhitespaceCharacter

With respect to tokens, it should be noted that there are several kinds of tokens: identifiers, keywords, literals, operators, and punctuators. White space and comments are not tokens, though they act as separators for tokens.

Token:

Identifier
Keyword
Literal
OperatorOrPunctuator

With respect to identifiers, a regular identifier begins with a letter or underscore and then any sequence of letter, underscore, dollar sign, or digit. An escaped identifier is enclosed in square brackets. It contains any sequence of Text literal characters.

Identifier:

IdentifierBegin IdentifierCharactersₒₚₜ
IdentifierVerbatim

IdentifierBegin:

_{—}
Letter

IdentifierCharacter:

IdentifierBegin
$
DecimalDigit

IdentifierCharacters:

IdentifierCharacter
IdentifierCharacters IdentifierCharacter

IdentifierVerbatim:

[ IdentifierVerbatimCharacters ]

IdentifierVerbatimCharacter:

none of ]
IdentifierVerbatimEscape

IdentifierVerbatimCharacters:

IdentifierVerbatimCharacter
IdentifierVerbatimCharacters IdentifierVerbatimCharacter

IdentifierVerbatimEscape:

\\
\]

Letter:

a..z
A..Z

DecimalDigit:

0..9

DecimalDigits:

DecimalDigit
DecimalDigits DecimalDigit

Referring next to keywords, A keyword is an identifier-like sequence of characters that is reserved, and cannot be used as an identifier except when escaped with square brackets [ ].

Keyword: oneof:

any empty error export false final id import interleave language
labelof left module null precedence right syntax token true
valuesof

The following keywords are reserved for future use:

checkpoint identifier nest override new virtual partial

With respect to literals, it should be noted that a literal is a source code representation of a value. Literals may be ascribed with a type to override the default type ascription.

Literal:

DecimalLiteral
IntegerLiteral
LogicalLiteral
NullLiteral
TextLiteral

It should also be noted that decimal literals may be used to write real-number values.

DecimalLiteral:

DecimalDigits . DecimalDigits

Examples of decimal literals include:

0.0
12.3
999999999999999.999999999999999

Integer literals may be used to write integral values.

IntegerLiteral:

-ₒₚₜ DecimalDigits

Examples of integer literals include:

0
123
999999999999999999999999999999
−42

Logical literals may be used to write logical values.

LogicalLiteral: one of

true false

Examples of logical literals are:

true
false

Referring next to text literals, M_{g} supports two forms of Text literals: regular text literals and verbatim text literals. In certain contexts, text literals must be of length one (single characters). However, M_{g} does not distinguish syntactically between strings and characters.

A regular text literal consists of zero or more characters enclosed in single or double quotes, as in “hello” or ‘hello’, and may include both simple escape sequences (such as \t for the tab character), and hexadecimal and Unicode escape sequences. A verbatim Text literal includes a ‘commercial at’ character (@) followed by a single- or double-quote character (′ or ″), zero or more characters, and a closing quote character that matches the opening one. A simple example is @“hello”. In a verbatim text literal, the characters between the delimiters are interpreted exactly as they occur in the compilation unit, the only exception being a SingleQuoteEscapeSequence or a DoubleQuoteEscapeSequence, depending on the opening quote. In particular, simple escape sequences, and hexadecimal and Unicode escape sequences are not processed in verbatim text literals. A verbatim text literal may span multiple lines. A simple escape sequence represents a Unicode character encoding, as described in the Table T-1 below.

TABLE T-1

| Escape sequence | Character name | Unicode encoding |
|---|---|---|
| \′ | Single quote | 0x0027 |
| \″ | Double quote | 0x0022 |
| \\ | Backslash | 0X005C |
| \0 | Null | 0X0000 |
| \a | Alert | 0x0007 |
| \b | Backspace | 0X0008 |
| \f | Form feed | 0X000C |
| \n | New line | 0x000A |
| \r | Carriage return | 0x000D |
| \t | Horizontal tab | 0x0009 |
| \v | Vertical tab | 0x000B |

Since M_{g} uses a 16-bit encoding of Unicode code points in Text values, a Unicode character in the range U+10000 to U+10FFFF is not considered a Text literal of length one (a single character), but is represented using a Unicode surrogate pair in a Text literal.

Unicode characters with code points above 0x10FFFF are not supported. Multiple translations are not performed. For instance, the text literal \u005Cu005C is equivalent to \u005C rather than \. The Unicode value U+005C is the character \. A hexadecimal escape sequence represents a single Unicode character, with the value formed by the hexadecimal number following the prefix.

TextLiteral:

’ SingleQuotedCharactersₒₚₜ ’
” DoubleQuotedCharactersₒₚₜ ”
@ ’ SingleQuotedVerbatimCharactersₒₚₜ ’
@ ” DoubleQuotedVerbatimCharactersₒₚₜ ”

CharacterEscape:

CharacterEscapeHex
CharacterEscapeSimple
CharacterEscapeUnicode

Character:

CharacterSimple
CharacterEscape

Characters:

Character
Characters Character

CharacterEscapeHex:

CharacterEscapeHexPrefix HexDigit
CharacterEscapeHexPrefix HexDigit HexDigit
CharacterEscapeHexPrefix HexDigit HexDigit HexDigit
CharacterEscapeHexPrefix HexDigit HexDigit HexDigit HexDigit

CharacterEscapeHexPrefix: one of

\x \X

CharacterEscapeSimple:

\ CharacterEscapeSimpleCharacter

CharacterEscapeSimpleCharacter: one of

’ ” \ 0 a b f n r t v

CharacterEscapeUnicode:

\u HexDigit HexDigit HexDigit HexDigit
\U HexDigit HexDigit HexDigit HexDigit HexDigit HexDigit
HexDigit HexDigit

DoubleQuotedCharacter:

DoubleQuotedCharacterSimple
CharacterEscape

DoubleQuotedCharacters:

DoubleQuotedCharacter
DoubleQuotedCharacters DoubleQuotedCharacter

DoubleQuotedCharacterSimple: none of

”
\
NewLineCharacter

SingleQuotedCharacterSimple: none of

’
\
NewLineCharacter

DoubleQuotedVerbatimCharacter:

none of ”
DoubleQuotedVerbatimCharacterEscape

DoubleQuotedVerbatimCharacterEscape:

” ”

DoubleQuotedVerbatimCharacters:

DoubleQuotedVerbatimCharacter
DoubleQuotedVerbatimCharacters DoubleQuotedVerbatimCharacter

SingleQuotedVerbatimCharacter:

none of ”
SingleQuotedVerbatimCharacterEscape

SingleQuotedVerbatimCharacterEscape:

” ”

SingleQuotedVerbatimCharacters:

SingleQuotedVerbatimCharacter
SingleQuotedVerbatimCharacters SingleQuotedVerbatimCharacter

Examples of text literals include:

‘a’
‘\u2323’
‘\x2323’
‘2323’
“Hello World”
@“““Hello,
World”””
“\u2323”

The null literal is equal to no other value.

NullLiteral:

null

An example of the null literal is:
null

In an embodiment, there are several kinds of operators and punctuators. Operators are used in expressions to describe operations involving one or more operands. For example, the expression a+b uses the + operator to add the two operands a and b. Punctuators are for grouping and separating.

OperatorOrPunctuator: one of

[ ] ( ) . , : ; ? = => + − * & | \hat{ } { } # .. @ ’ ”

In one aspect, Pre-processing directives provide the ability to conditionally skip sections of source files, to report error and warning conditions, and to delineate distinct regions of source code as a separate pre-processing step.

PPDirective:

PPDeclaration
PPConditional
PPDiagnostic
PPRegion

The following pre-processing directives are available:

#define and #undef, which are used to define and undefine, respectively,

conditional compilation symbols.

#if, #else, and #endif, which are used to conditionally skip sections of

source code.

A pre-processing directive may always occupy a separate line of source code and may always begins with a # character and a pre-processing directive name. White space may occur before the # character and between the # character and the directive name. A source line containing a #define, #undef, #if, #else, or #endif directive may end with a single-line comment. Delimited comments (the /* */ style of comments) are not permitted on source lines containing pre-processing directives. Pre-processing directives are neither tokens nor part of the syntactic grammar of M_{g}. However, pre-processing directives can be used to include or exclude sequences of tokens and can in that way affect the meaning of an M_{g} program. For example, after pre-processing the source text:

#define A
#undef B
language C
{
#if A

syntax F = “ABC”;

#else

syntax G = “HIJ”;

#endif
#if B

syntax H = “KLM”;

#else

syntax I = “DEF”;

#endif
}

results in the exact same sequence of tokens as the source text:

language C
{

syntax F = “ABC”;
syntax I = “DEF”;

}

Thus, whereas lexically, the two programs are quite different, syntactically, they are identical.

Conditional compilation functionality is provided by the #if, #else, and #endif directives is controlled through pre-processing expressions and conditional compilation symbols.

ConditionalSymbol:

Any IdentifierOrKeyword except true or false

A conditional compilation symbol has two possible states: defined or undefined. At the beginning of the lexical processing of a source file, a conditional compilation symbol is undefined unless it has been explicitly defined by an external mechanism (such as a command-line compiler option). When a #define directive is processed, the conditional compilation symbol named in that directive becomes defined in that source file. The symbol remains defined until an #undef directive for that same symbol is processed, or until the end of the source file is reached. An implication of this is that #define and #undef directives in one source file have no effect on other source files in the same program.

When referenced in a pre-processing expression, a defined conditional compilation symbol has the Logical value true, and an undefined conditional compilation symbol has the Logical value false. There is no requirement that conditional compilation symbols be explicitly declared before they are referenced in pre-processing expressions. Instead, undeclared symbols are simply undefined and thus have the value false. In an embodiment, conditional compilation symbols can only be referenced in #define and #undef directives and in pre-processing expressions.

Pre-processing expressions can occur in #if directives. The operators !, ==, !=, && and ∥ are permitted in pre-processing expressions, and parentheses may be used for grouping.

PPExpression:

Whitespaceₒₚₜ PPOrExpression Whitespaceₒₚₜ

OrExpression:

PPAndExpression
PPOrExpression Whitespaceₒₚₜ || Whitespaceₒₚₜ PPAndExpression

PPAndExpression:

PPEqualityExpression
PPAndExpression Whitespaceₒₚₜ && Whitespaceₒₚₜ
PPEqualityExpression

PPEqualityExpression:

PPUnaryExpression
PPEqualityExpression Whitespaceₒₚₜ == Whitespaceₒₚₜ
PPUnaryExpression
PPEqualityExpression Whitespaceₒₚₜ != Whitespaceₒₚₜ
PPUnaryExpression

PPUnaryExpression:

PPPrimaryExpression
! Whitespaceₒₚₜ PPUnaryExpression

PPPrimaryExpression:

true
false
ConditionalSymbol
( Whitespaceₒₚₜ PPExpression Whitespaceₒₚₜ )

When referenced in a pre-processing expression, a defined conditional compilation symbol has the Logical value true, and an undefined conditional compilation symbol has the Logical value false.

Evaluation of a pre-processing expression always yields a Logical value. The rules of evaluation for a pre-processing expression are the same as those for a constant expression, except that the only user-defined entities that can be referenced are conditional compilation symbols.

Declaration directives are used to define or undefine conditional compilation symbols.

PPDeclaration:

Whitespaceₒₚₜ # Whitespaceₒₚₜ define Whitespace ConditionalSymbol
PPNewLine
Whitespaceₒₚₜ # Whitespaceₒₚₜ undef Whitespace ConditionalSymbol
PPNewLine

PPNewLine:

Whitespaceₒₚₜ SingleLineCommentₒₚₜ NewLine

The processing of a #define directive causes the given conditional compilation symbol to become defined, starting with the source line that follows the directive. Likewise, the processing of an #undef directive causes the given conditional compilation symbol to become undefined, starting with the source line that follows the directive.

A #define may define a conditional compilation symbol that is already defined, without there being any intervening #undef for that symbol. The example below defines a conditional compilation symbol A and then defines it again.

#define A
#define A

A #undef may “undefine” a conditional compilation symbol that is not defined. The example below defines a conditional compilation symbol A and then undefines it twice; although the second #undef has no effect, it is still valid.

#define A
#undef A
#undef A

Conditional compilation directives are used to conditionally include or exclude portions of a source file.

PPConditional:

PPIfSection PPElseSectionₒₚₜ PPEndif

PPIfSection:

Whitespaceₒₚₜ # Whitespaceₒₚₜ if Whitespace PPExpression
PPNewLine ConditionalSectionₒₚₜ

PPElseSection:

Whitespaceₒₚₜ # Whitespaceₒₚₜ else PPNewLine ConditionalSectionₒₚₜ

PPEndif:

Whitespaceₒₚₜ # Whitespaceₒₚₜ endif PPNewLine

ConditionalSection:

InputSection
SkippedSection

SkippedSection:

SkippedSectionPart
SkippedSection SkippedSectionPart

SkippedSectionPart:

SkippedCharactersₒₚₜ NewLine
PPDirective

SkippedCharacters:

Whitespaceₒₚₜ NotNumberSign InputCharactersₒₚₜ

NotNumberSign:

Any InputCharacter except #

As indicated by the syntax, conditional compilation directives must be written as sets consisting of, in order, an #if directive, zero or one #else directive, and an #endif directive. Between the directives are conditional sections of source code. Each section is controlled by the immediately preceding directive. A conditional section may itself contain nested conditional compilation directives provided these directives form complete sets.

A PPConditional selects at most one of the contained ConditionalSections for normal lexical processing:

The PPExpressions of the #if directives are evaluated in order until one
yields true.

If an expression yields true, the ConditionalSection of the
corresponding directive is selected.

If all PPExpressions yield false, and if an #else directive is present, the

ConditionalSection of the #else directive is selected.

Otherwise, no ConditionalSection is selected.

The selected ConditionalSection, if any, is processed as a normal InputSection: the source code contained in the section must adhere to the lexical grammar; tokens are generated from the source code in the section; and pre-processing directives in the section have the prescribed effects.

The remaining ConditionalSections, if any, are processed as SkippedSections: except for pre-processing directives, the source code in the section need not adhere to the lexical grammar; no tokens are generated from the source code in the section; and pre-processing directives in the section must be lexically correct but are not otherwise processed. Within a ConditionalSection that is being processed as a Skipped-Section, any nested ConditionalSections (contained in nested #if . . . #endif and #region . . . #end region constructs) are also processed as SkippedSections.

Except for pre-processing directives, skipped source code is not subject to lexical analysis. For example, the following is valid despite the unterminated comment in the #else section:

| | |
|---|---|
| #define Debug | // Debugging on |

module HelloWorld {

language HelloWorld {

syntax Main =

#if Debug

“Hello World”

;

#else

/* Unterminated comment!

#endif

}

}

Note, that pre-processing directives are required to be lexically correct even in skipped sections of source code.
Pre-processing directives are not processed when they appear inside multi-line input elements. For example, the program:

module HelloWorld {

language HelloWorld {

syntax Main = @‘

#if Debug

“Hello World”

;

#else

/* Unterminated comment!

#endif’

}

}

generates a language which recognizes the value:

#if Debug

“Hello World”

;

#else

/* Unterminated comment!

#endif

In peculiar cases, the set of pre-processing directives that is processed might depend on the evaluation of the PPExpression. The example:

#if X

/*

#else

/* */ syntax Q = empty;

#endif

always produces the same token stream (syntax Q=empty;), regardless of whether or not X is defined. If X is defined, the only processed directives are #if and #endif, due to the multi-line comment. If X is undefined, then three directives (#if, #else, #endif) are part of the directive set.

Referring next to text pattern expressions, it should be noted that text pattern expressions perform operations on the sets of possible text values that one or more terms recognize.

With respect to primary expressions, it should be appreciated that a primary expression may be a text literal, a reference to a syntax or token rule, an expression indicating a repeated sequence of primary expressions of a specified length, an expression indicating any of a continuous range of characters, or an inline sequence of pattern declarations. The following grammar reflects this structure.

Primary:

ReferencePrimary
TextLiteral
RepetitionPrimary
CharacterClassPrimary
InlineRulePrimary
AnyPrimary

A character class is a compact syntax for a range of continuous characters. This expression requires that the text literals be of length 1 and that the Unicode offset of the right operand be greater than that of the left.

CharacterClassPrimary:

TextLiteral .. TextLiteral

The expression “0”. “9” is equivalent to:

“0”|“1”|“2”|“3”|“4”|“5”|“6”|“7”|“8”|“9”|

A reference primary is the name of another rule possibly with arguments for parameterized rules. All rules defined within the same language can be accessed without qualification.

ReferencePrimary:

GrammarReference

GrammarReference:

Identifier
GrammarReference . Identifier
GrammarReference . Identifier ( Type Arguments )
Identifier ( TypeArguments )

TypeArguments:

PrimaryExpression
TypeArguments , PrimaryExpression

Note that whitespace between a rule name and its arguments list is significant to discriminate between a reference to a parameterized rule and a reference without parameters and an inline rule. In a reference to a parameterized rule, no whitespace is permitted between the identifier and the arguments.

In an embodiment, repetition operators recognize a primary expression repeated a specified number of times. The number of repetitions can be stated as a (possibly open) integer range or using one of the Kleene operators, ?, +, *.

RepetitionPrimary:

Primary Range
Primary CollectionRanges

Range:

?
*
+

CollectionRanges:

# IntegerLiteral
# IntegerLiteral .. IntegerLiteralₒₚₜ

The left operand of . . must be greater than zero and less than the right operand of . . , if present.
“A”#5 recognizes exactly 5 “A”s “AAAAA”
“A”#2 . . 4 recognizes from 2 to 4 “AA”, “AAA”, “AAAA” “A”s
“A”#3 . . recognizes 3 or more “A”s “AAA”, “AAAA”, “AAAAA”, . . . .
   The Kleene operators can be defined in terms of the collection range operator:

“A” ? is equivalent to “A”#0 . . 1

“A”+ is equivalent to “A”1 . .

“A”* is equivalent to “A”#0 . .

An inline rule may also be provided as a means to group pattern declarations together as a term.

InlineRulePrimary:

( ProductionDeclarations )

An inline rule is typically used in conjunction with a range operator:

“A” (“,” “A”)*

recognizes 1 or more “A” s separated by commas. Although syntactically legal, variable bindings within inline rules are not accessible within the constructor of the containing production.

The “any” term is a wildcard that matches any text value of length 1.

Any:
any
   “1”, “z”, and “*” all match any.

The error production enables error recover. Consider the following example:

module Hello World {

language Hello World {

syntax Main

= HelloList;

token Hello

= “Hello”;

checkpoint syntax HelloList

= Hello
| HelloList “,” Hello
| HelloList “,” error;

}

}

The language recognizes the text “Hello, Hello, Hello” as expected and produces the following default output:

Main[

HelloList[

HelloList[

HelloList[

Hello

],
”
Hello

],
”
Hello

]

]

The text “Hello,hello,Hello” is not in the language because the second “h” is not capitalized (and case sensitivity is true). However, rather than stop at “h”, the language processor matches “h” to the error token, then matches “e” to the error token, etc. Until it reaches the comma. At this point the text conforms to the language and normal processing can continue. The language process reports the position of the errors and produces the following output:

Main[

HelloList[

HelloList[

HelloList[

Hello

],
error[″hello″],

],
”
Hello

]

]

Hello occurs twice instead of three times as above and the text the error token matched is returned as error [“hello”].

Referring next to term operators, it should be noted that a primary term expression can be thought of as the set of possible text values that it recognizes. The term operators perform the standard set difference, intersection, and negation operations on these sets. (Pattern declarations perform the union operation with |.)

TextPatternExpression:

Difference

Difference:

Intersect
Difference - Intersect

Intersect:

Inverse
Intersect & Inverse

Inverse:

Primary
\hat{ } Primary

Inverse requires every value in the set of possible text values to be of length 1.

(“11”|“12”)−(“12”|“13”) recognizes “11”.

(“11”|“12”) & (“12”|“13”) recognizes “12”.

[symbol] (“11”|“12”) is an error.

[symbol] (“11”|“2”) recognizes any text value of length 1 other than “1” or “2”.

Referring next to productions, it should be appreciated that a production is a pattern and an optional constructor. Each production is a scope. The pattern may establish variable bindings which can be referenced in the constructor. A production can be qualified with a precedence that is used to resolve a tie if two productions match the same text.

ProductionDeclaration:

ProductionPrecedenceₒₚₜ PatternDeclaration Constructorₒₚₜ

Constructor

=> Term Constructor

ProductionPrecedence:

precedence IntegerLiteral :

A pattern declaration is a sequence of term declarations or the built-in pattern empty which matches “ ”.

PatternDeclaration:

empty
TermDeclarationsₒₚₜ

TermDeclarations:

TermDeclaration
TermDeclarations TermDeclaration

A term declaration includes a pattern expression with an optional variable binding, precedence and attributes. The built-in term error is used for error recovery.

TermDeclaration:

error
Attributesₒₚₜ TermPrecedenceₒₚₜ VariableBindingₒₚₜ
TextPatternExpression

VariableBinding:

Name :

TermPrecedence:

left ( IntegerLiteral )
right ( IntegerLiteral )

A variable associates a name with the output from a term which can be used in the constructor. The error term is used in conjunction with the checkpoint rule modifier to facilitate error recovery.

A term constructor is the syntax for defining the output of a production. A node in a term constructor can be, for example, an atom including a literal, a reference to another term, or an operation on a reference; an ordered collection of successors with an optional label; or an unordered collection of successors with an optional label. The following grammar mirrors this structure.

Term Constructor:

TopLevelNode

Node:

Atom
OrderedTerm
UnorderedTerm

TopLevelNode:

TopLevelAtom
OrderedTerm
UnorderedTerm

Nodes:

Node
Nodes , Node

OrderedTerm:

Labelₒₚₜ [ Nodesₒₚₜ ]

UnorderedTerm:

Labelₒₚₜ { Nodesₒₚₜ }

Label:

Identifier
id ( Atom )

Atom:

TopLevelAtom
valuesof ( VariableReference )

TopLevelAtom:

TextLiteral
DecimalLiteral
LogicalLiteral
IntegerLiteral
NullLiteral
VariableReference
labelof ( VariableReference )

VariableReference:

Identifier

Each production defines a scope. The variables referenced in a constructor must be defined within the same production's pattern. Variables defined in other productions in the same rule cannot be referenced. The same variable name can be used across alternatives in the same rule. Consider three alternatives for encoding the output of the same production. First, the default constructor:

module Expression {

language Expression {

token Digits = (“0”..“9”)+;
syntax Main = E;
syntax E

= Digits
| E “+” E ;

}

}

Processing the text “1+2” yields:

### Main[E[E[1], +, E[2]]]

This output reflects the structure of the grammar and may not be the most useful form for further processing. The second alternative cleans the output up considerably:

module Expression {

language Expression {

token Digits = (“0”..“9”)+;
syntax Main

= e:E=> e;

syntax E

= d:Digits => d
;| l:E “+” r:E => Add[l,r] ;

}

}

Processing the text “1+2” with this language yields:

Add[1, 2]

This grammar uses three common patterns: productions with a single term are passed through (this is done for the single production in Main and the first production in E); a label, Add, is used to designate the operator; and position is used to distinguish the left and right operand. The third alternative uses a record like structure to give the operands names:

module Expression {

language Expression {

token Digits = (“0”..“9”)+;
syntax Main

= e:E => e;

syntax E

= d:Digits => d
| l:E “+” r:E => Add{Left{l},Right{r}} ;

}

}

Processing the text “1+2” with this language yields:

Add{Left{1}, Right{2}}

Although somewhat more verbose than the prior alternative, this output does not rely on ordering and forces consumers to explicitly name Left or Right operands. Although either option works, this has proven to be more flexible and less error prone.

Referring next to constructor operators, constructor operators allow a constructor to use a variable reference as a label, extract the successors of a variable reference or extract the label of a variable reference. For instance, consider generalizing the example above to support multiple operators. This could be done by adding a new production for each operator −, *, /, [symbol] . Alternatively a single rule can be established to match these operators and the output of that rule can be used as a label using id:

module Expression {

language Expression {

token Digits = (“0”..“9”)+;
syntax Main

= e:E => e;

syntax Op

= “+” => “Add”
| “−” => “Subtract”
| “*” => “Multiply”
| “/” => “Divide” ;

syntax E

= d:Digits => d
| l:E o:Op r:E => id(o){Left[l],Right[r]} ;

}

}

Processing the text “1+2” with this language yields the same result as above.
Processing “½” yields:

Divide {Left{1}, Right{2}}

This language illustrates the id operator.

The valuesof operator extract the successors of a variable reference. It is used to flatten nested output structures. For instance, consider the language:

module Digits {

language Digits {

syntax Main = DigitList ;
token Digit = “0”..“9”;
syntax DigitList

= Digit
| DigitList “,” Digit ;

}

}

Processing the text “1, 2, 3” with this language yields:

Main[

DigitList[

DigitList[

DigitList[

1

],
”
2

],
”
3

]

]

The following grammar uses valuesof and the pass through pattern above to simplify the output:

module Digits {

language Digits {

syntax Main = dl:DigitList => dl ;
token Digit = “0”..“9”;
syntax DigitList

= d:Digit => DigitList[d]
| dl:DigitList “,” d:Digit => DigitList[valuesof(dl),d] ;

}

}

Processing the text “1, 2, 3” with this language yields:

DigitList[1, 2, 3]

This output represents the same information more concisely.

If a constructor is not defined for a production the language process defines a default constructor. For a given production, the default projection is formed as follows. First, the label for the result is the name of the production's rule. Next, the successors of the result are an ordered sequence constructed from each term in the pattern. Then, * and ? create an unlabeled sequence with the elements. A “( )” then results in an anonymous definition. Namely, if it contains constructors (a:A=>a), then the output is the output of the constructor. Otherwise, if there are no constructors, then the default rule applied on the anonymous definition and the output is enclosed in square brackets [A's result]. It should then be noted that token rules do not permit a constructor to be specified and output text values. Also, interleave rules do not permit a constructor to be specified and do not produce output. For instance, consider the following language:

module ThreeDigits {

language ThreeDigits {

token Digit = “0”..“9”;
syntax Main

= Digit Digit Digit ;

}

}

Given the text “123” the default output of the language processor follows:

Main[

1,
2,
3

]

The M_{g} language processor is tolerant of such ambiguity as it is recognizing subsequences of text. However, it is an error to produce more than one output for an entire text value. Precedence qualifiers on productions or terms determine which of the several outputs should be returned. With respect to production precedence, consider, for example, the classic dangling else problem as represented in the following language:

module IfThenElse {

language IfThenElse {

syntax Main = S;
syntax S

= empty
| “if” E “then” S
| “if” E “then” S “else” S;

syntax E = empty;
interleave Whitespace = “ ”;

}

}

Given the input “if then if then else”, two different output are possible. Either the else binds to the first if-then:

if
then

if
then

else

Or it binds to the second if-then:

if
then

if
then
else

The following language produces the output immediately above, binding the else to the second if-then.

module IfThenElse {

language IfThenElse {

syntax Main = S;
syntax S

= empty
| precedence 2: “if” E “then” S
| precedence 1: “if” E “then” S “else” S;

syntax E = empty;
interleave Whitespace = “ ”;

}

}

Switching the precedence values produces the first output.

With respect to term precedence, consider a simple expression language which recognizes:

2+3+4

5*6*7

2+3*4

2̂3̂4

The result of these expressions can depend on the order in which the operators are reduced. 2+3+4 yields 9 whether 2+3 is evaluated first or 3+4 is evaluated first. Likewise, 5*6*7 yields 210 regardless of the order of evaluation. However, this is not the case for 2+3*4. If 2+3 is evaluated first yielding 5, 5*4 yields 20. While if 3*4 is evaluated first yielding 12, 2+12 yields 14. This difference manifests itself in the output of the following grammar:

module Expression {

language Expression {

token Digits = (“0”..“9”)+;
syntax Main = e:E => e;
syntax E

= d:Digits => d
| “(“ e:E ”)” => e
| l:E “\hat{ }” r:E => Exp[l,r]
| l:E “*” r:E => Mult[l,r]
| l:E “+”r:E => Add[l,r];

interleave Whitespace = “ ”;

}

}

“2+3*4” can result in two outputs:

Mult[Add[2, 3], 4]
Add[2, Mult[3, 4]]

According to conventional rules, the result of this expression is 14 because multiplication is performed before addition. This is expressed in M_{g} by assigning “*” a higher precedence than “+”. In this case the result of an expression changed with the order of evaluation of different operators.

The order of evaluation of a single operator can matter as well. Consider 2 [symbol] 3 [symbol] 4. This could result in either 8 [symbol] 4 or 2 [symbol] 81. In term of output, there are two possibilities:

Exp[Exp[2, 3], 4]
Exp[2, Exp[3, 4]]

In this case the issue is not which of several different operators to evaluate first but which in a sequence of operators to evaluate first, the leftmost or the right most. The rule in this case is less well established but most languages choose to evaluate the rightmost “̂” first yielding 2̂81 in this example.

The following grammar implements these rules using term precedence qualifiers. Term precedence qualifiers may only be applied to literals or references to token rules.

module Expression {

language Expression {

token Digits = (“0”..“9”)+;
syntax Main = E;
syntax E

= d:Digits => d
| “(“ e:E ”)” => e
| l:E right(3) “\hat{ }” r:E => Exp[l,r]
| l:E left(2) “*” r:E => Mult[l,r]
| l:E left(1) “+” r:E => Add[l,r];

interleave Whitespace = “ ”;

}

}

“̂” is qualified with right(3). right indicates that the rightmost in a sequence should be grouped together first. 3 is the highest precedence, so “̂” will be grouped most strongly.

Referring next to rules, a rule is a named collection of alternative productions. There are three kinds of rules: syntax, token, and interleave. A text value conforms to a rule if it conforms to any one of the productions in the rule. If a text value conforms to more than one production in the rule, then the rule is ambiguous.

The three different kinds of rules differ in how they treat ambiguity and how they handle their output.

RuleDeclaration:

Attributesₒₚₜ MemberModifiersₒₚₜ Kind Name RuleParametersₒₚₜ
RuleBodyₒₚₜ ;

Kind:

token
syntax
interleave

MemberModifiers:

MemberModifier
MemberModifiers MemberModifer

MemberModifier:

final
identifier

RuleBody:

= ProductionDeclarations

ProductionDeclarations:

ProductionDeclaration
ProductionDeclarations | ProductionDeclaration

The rule Main below recognizes the two text values “Hello” and “Goodbye”.

module HelloGoodby {

language HelloGoodbye {

syntax Main

= “Hello”
| “Goodbye”;

}

}

With respect to token rules, token rules recognize a restricted family of languages. However, token rules can be negated, intersected and subtracted which is not the case for syntax rules. Attempting to perform these operations on a syntax rule results in an error. The output from a token rule is the text matched by the token. No constructor may be defined.

Token rules do not permit precedence directives in the rule body. They have a built in protocol to deal with ambiguous productions. A language processor attempts to match all tokens in the language against a text value starting with the first character, then the first two, etc. If two or more productions within the same token or two different tokens can match the beginning of a text value, a token rule will choose the production with the longest match. If all matches are exactly the same length, the language processor will choose a token rule marked final if present. If no token rule is marked final, all the matches succeed and the language processor evaluates whether each alternative is recognized in a larger context. The language processor retains all of the matches and begins attempting to match a new token starting with the first character that has not already been matched.

An identifier modifier may also be included, which applies only to tokens. It is used to lower the precedence of language identifiers so they do not conflict with language keywords.

In an embodiment, syntax rules recognize all languages that M_{g} is capable of defining. The main start rule must be a syntax rule. Syntax rules allow all precedence directives and may have constructors.

Interleave rules may also be provided. An interleave rule recognizes the same family of languages as a token rule and also cannot have constructors. Further, interleave rules cannot have parameters and the name of an interleave rule cannot be references. Text that matches an interleave rule is excluded from further processing. The following example demonstrates whitespace handling with an interleave rule:

module HelloWorld {

language HelloWorld {

syntax Main =

= Hello World;

token Hello

= “Hello”;

token World

= “World”;

interleave Whitespace

= “ ”;

}

}

This language recognizes the text value “Hello World”. It also recognizes “Hello world”, “Hello world”, “Hello world”, and “HelloWorld”. It does not recognize “He llo world” because “He” does not match any token.
An inline rule may also be provided, which is an anonymous rule embedded within the pattern of a production. The inline rule is processed as any other rule however it cannot be reused since it does not have a name. Variables defined within an inline rule are scoped to their productions as usual. A variable may be bound to the output of an inline rule as with any pattern.

In the following Example 1 and Example 2 recognize the same language and produce the same output. Example 1 uses a named rule AppleOrOrange while Example 2 states the same rule inline.

module Example {

language Example1 {

syntax Main

= aos:AppleOrOrange*

=> aos;

syntax AppleOrOrange

= “Apple” => Apple{ }
| “Orange” => Orange{ };

}
language Example2 {

syntax Main

= aos:(“Apple” => Apple{ } | “Orange” => Orange{ })*

=> aos;

}

}

Rule parameters may also be included in which a rule defines parameters which can be used within the body of the rule.

RuleParameters:

( RuleParameterList )

RuleParameterList:

RuleParameter
RuleParameterList , RuleParameter

RuleParameter:

Identifier

A single rule identifier may have multiple definitions with different numbers of parameters. The following example uses List(Content, Separator) to define List(content) with a default separator of “,”.

module HelloWorld {

language HelloWorld {

syntax Main

= List(Hello);

token Hello

= “Hello”;

syntax List(Content, Separator)

= Content
| List(Content,Separator) Separator Content;

syntax List(Content) = List(Content, “,”);

}

}

This language will recognize “Hello”, “Hello,Hello”, “Hello,Hello,Hello”, etc.

A language may also be provided which is a named collection of rules for imposing structure on text.

LanguageDeclaration:

Attributesₒₚₜ language Name LanguageBody

LanguageBody:

{ RuleDeclarationsₒₚₜ }

RuleDeclarations:

RuleDeclaration
RuleDeclarations RuleDeclaration

The language that follows recognizes the single text value “Hello World”:

module HelloWorld {

language HelloWorld {

syntax Main

= “Hello World”;

}

}

It should be appreciated that a language may consist of any number of rules. The following language recognizes the single text value “Hello World”:

module HelloWorld {

language HelloWorld {

syntax Main

= Hello Whitespace World;

token Hello

= “Hello”;

token World

= “World”;

token Whitespace

= “ ”;

}

}

The three rules Hello, world, and whitespace recognize the three single text values “Hello”, “world”, and “ ” respectively. The rule Main combines these three rules in sequence. Main is the distinguished start rule for a language. A language recognizes a text value if and only if Main recognizes a value. Also, the output for Main is the output for the language.

It should also be noted that rules are members of a language. A language can use rules defined in another language using member access notation. The Helloworld language recognizes the single text value “Hello world” using rules defined in the words language:

module HelloWorld {

language Words {

token Hello

= “Hello”;

token World

= “World”;

}
language HelloWorld {

syntax Main

= Words.Hello Whitespace Words.World;

token Whitespace =

= “ ”;

}

}

All rules defined within the same module are accessible in this way. In an embodiment, rules defined in other modules must be exported and imported.

Referring next to modules, it should be noted that an M_{g} module is a scope which contains declarations of languages (§Error! Reference source not found.). Declarations exported by an imported module are made available in the importing module. Thus, modules override lexical scoping that otherwise governs M_{g} symbol resolution. Modules themselves do not nest. In an embodiment, several modules may be contained within a Compilation Unit, typically a text file.

CompilationUnit:

ModuleDeclarations

ModuleDeclarations:

ModuleDeclaration
ModuleDeclarations ModuleDeclaration

A ModuleDeclaration is a named container/scope for language declarations.

ModuleDeclaration:

module QualifiedIdentifer ModuleBody ;ₒₚₜ

QualifiedIdentifier:

Identifier
QualifiedIdentifier . Identifier

ModuleBody:

{ ImportDirectives ExportDirectives ModuleMemberDeclarations }

ModuleMemberDeclarations:

ModuleMemberDeclaration
ModuleMemberDeclarations ModuleMemberDeclaration

ModuleMemberDeclaration:

LanguageDeclaration

Each ModuleDeclaration has a QualifiedIdentifier that uniquely qualifies the declarations contained by the module. Each ModuleMemberDeclaration may be referenced either by its Identifier or by its fully qualified name by concatenating the QualifiedIdentifier of the ModuleDeclaration with the Identifier of the ModuleMemberDeclaration (separated by a period). For example, given the following ModuleDeclaration:

module BaseDefinitions {

export Logical;
language Logical {

syntax Literal = “true” | “false”;

}

}

The fully qualified name of the language is BaseDefinitions.Logical, or using escaped identifiers, [BaseDefinitions].[Logical]. It is always legal to use a fully qualified name where the name of a declaration is expected. Modules are not hierarchical or nested. That is, there is no implied relationship between modules whose QualifiedIdentifier share a common prefix. For example, consider these two declarations:

module A {

language L {

token I = (‘0’..‘9’)+;

}

}
module A.B {

language M {

token D = L.I‘.’L.I;

}

}

Module A. B is in error, as it does not contain a declaration for the identifier L. That is, the members of Module A are not implicitly imported into Module A.B.

In an embodiment, M_{g} uses ImportDirectives and ExportDirectives to explicitly control which declarations may be used across module boundaries.

ExportDirectives:

ExportDirective
ExportDirectives ExportDirective

ExportDirective:

export Identifiers;

ImportDirectives:

ImportDirective
ImportDirectives ImportDirective

ImportDirective:

import ImportModules ;
import QualifiedIdentifier { ImportMembers } ;

ImportMember:

Identifier ImportAliasₒₚₜ

ImportMembers:

ImportMember
ImportMembers , ImportMember

ImportModule:

QualifiedIdentifier ImportAliasₒₚₜ

ImportModules:

ImportModule
ImportModules , ImportModule

ImportAlias:

as Identifier

A ModuleDeclaration contains zero or more ExportDirectives, each of which makes a ModuleMemberDeclaration available to declarations outside of the current module. A ModuleDeclaration contains zero or more ImportDirectives, each of which names a ModuleDeclaration whose declarations may be referenced by the current module. A ModuleMemberDeclaration may only reference declarations in the current module and declarations that have an explicit ImportDirective in the current module. An ImportDirective is not transitive, that is, importing module A does not import the modules that A imports. For example, consider this ModuleDeclaration:

module Language.Core {

export Base;
language Internal {

token Digit = ‘0’..‘9’;
token Letter = ‘A’..‘Z’ | ‘a’..‘z’;

}
language Base {

token Identifier = Letter (Letter | Digit)*;

}

}

The definition Language.Core.Internal may only be referenced from within the module Language.Core. The definition Language.Core.Base may be referenced in any module that has an ImportDirective for module Language. Core, as shown in this example:

module Language.Extensions {

import Language.Core;
language Names {

syntax QualifiedIdentifier

= Language.Core.Base.Identifier‘.’Language.Core.Base.Identifier;

}

}

The example above uses the fully qualified name to refer to Language.Core.Base. An ImportDirective may also specify an ImportAlias that provides a replacement Identifier for the imported declaration:

module Language.Extensions {

import Language.Core as lc;
language Names {

syntax QualifiedIdentifier

= lc.Base.Identifier‘.’lc.Base.Identifier;

}

}

An ImportAlias replaces the name of the imported declaration. That means that the following is an error:

module Language.Extensions {

import Language.Core as lc;
language Names {

syntax QualifiedIdentifier

= Language.Core.Base.Identifier‘.’Language.Core.Base.Identifier;

}

}

It is legal for two or more ImportDirectives to import the same declaration, provided they specify distinct aliases. For a given compilation episode, at most one ImportDirective may use a given alias.

If an ImportDirective imports a module without specifying an alias, the declarations in the imported module may be referenced without the qualification of the module name. That means the following is also legal.

module Language.Extensions {

import Language.Core;
language Names {

syntax QualifiedIdentifier = Base.Identifier‘.’Base.Identifier;

}

}

When two modules contain same-named declarations, there is a potential for ambiguity. The potential for ambiguity is not an error—ambiguity errors are detected lazily as part of resolving references. For instance, consider the following two modules:

module A {

export L;
language L {

token X = ‘1’;

}

}
module B {

export L;
language L {

token X = ‘2’;

}

}

It is legal to import both modules either with or without providing an alias:

module C {

import A, B;
language M {

token Y = ‘3’;

}

}

This is legal because ambiguity is only an error for references, not declarations. That means that the following is a compile-time error:

module C {

import A, B;
language M {

token Y = L.X | ‘3’;

}

}

This example can be made legal either by fully qualifying the reference to L:

module C {

import A, B;
language M {

token Y = A.L.X | ‘3’; // no error

}

}

or by adding an alias to one or both of the ImportDirectives:

module C {

import A;
import B as bb;
language M {

token Y = L.X | ‘3’; // no error, refers to A.L
token Z = bb.L.X | ‘3’; // no error, refers to B.L

}

}

An ImportDirective may either import all exported declarations from a module or only a selected subset of them. The latter is enabled by specifying ImportMembers as part of the directive. For example, Module Plot2D imports only Point2D and PointPolar from the Module Geometry:

module Geometry {

import Algebra;
export Geo2D, Geo3D;
language Geo2D {

syntax Point = ‘(’Numbers.Number‘,’Numbers.Number‘)’;
syntax PointPolar = ‘<’Numbers.Number‘,’Numbers.Number‘>’;

}
language Geo3D {

syntax Point =

‘(’Numbers.Number‘,’Numbers.Number‘,’Numbers.Number‘)’;

}

}
module Plot2D {

import Geometry {Geo2D};
language Paths {

syntax Path = ‘(’Geo2D.Point*‘)’;
syntax PathPolar = ‘(’Geo2D.PointPolar*‘)’;

}

}

An ImportDirective that contains an ImportMember only imports the named declarations from that module. This means that the following is a compilation error because module Plot3D references Geo3D which is not imported from module Geometry:

module Plot3D {

import Geometry {Geo2D};
language Paths {

syntax Path = ‘(’Geo3D.Point*‘)’;

}

}

An ImportDirective that contains an ImportAlias on a selected imported member assigns the replacement name to the imported declaration, hiding the original export name.

module Plot3D {

import Geometry {Geo3D as geo};
language Paths {

syntax Path = ‘(’geo.Point*‘)’;

}

}

Aliasing an individual imported member is useful to resolve occasional conflicts between imports. Aliasing an entire imported module is useful to resolve a systemic conflict. For example, when importing two modules, where one is a different version of the other, it is likely to get many conflicts. Aliasing at member level would lead to a correspondingly long list of alias declarations.

Referring next to attributes, it should be noted that attributes provide metadata which can be used to interpret the language feature they modify.

AttributeSections:

AttributeSection
AttributeSections AttributeSection

AttributeSection:

@{ Nodes }

In an embodiment a casesensitive attribute controls whether tokens are matched with our without case sensitivity. The default value is true. The following language recognizes “Hello world”, “HELLO world”, and “hELLo worLD”.

module HelloWorld {

@{CaseSensitive[false]}
language HelloWorld {

syntax Main

= Hello World;

token Hello

= “Hello”;

token World

= “World”;

interleave Whitespace

= “ ”;

}

}

### EXEMPLARY NETWORKED AND DISTRIBUTED ENVIRONMENTS

One of ordinary skill in the art can appreciate that the various embodiments described herein can be implemented in connection with any computer or other client or server device, which can be deployed as part of a computer network or in a distributed computing environment, and can be connected to any kind of data store. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may cooperate to perform one or more aspects of any of the various embodiments of the subject disclosure.

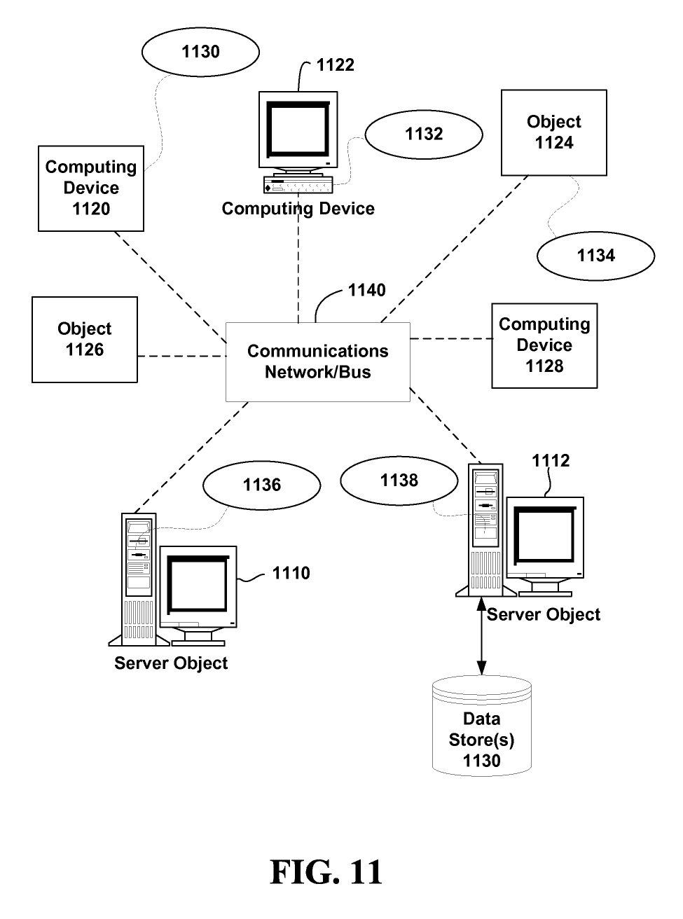

FIG. 11 provides a schematic diagram of an exemplary networked or distributed computing environment. The distributed computing environment comprises computing objects 1110, 1112, etc. and computing objects or devices 1120, 1122, 1124, 1126, 1128, etc., which may include programs, methods, data stores, programmable logic, etc., as represented by applications 1130, 1132, 1134, 1136, 1138. It can be appreciated that objects 1110, 1112, etc. and computing objects or devices 1120, 1122, 1124, 1126, 1128, etc. may comprise different devices, such as PDAs, audio/video devices, mobile phones, MP3 players, personal computers, laptops, etc.

Each object 1110, 1112, etc. and computing objects or devices 1120, 1122, 1124, 1126, 1128, etc. can communicate with one or more other objects 1110, 1112, etc. and computing objects or devices 1120, 1122, 1124, 1126, 1128, etc. by way of the communications network 1140, either directly or indirectly. Even though illustrated as a single element in FIG. 11, network 1140 may comprise other computing objects and computing devices that provide services to the system of FIG. 11, and/or may represent multiple interconnected networks, which are not shown. Each object 1110, 1112, etc. or 1120, 1122, 1124, 1126, 1128, etc. can also contain an application, such as applications 1130, 1132, 1134, 1136, 1138, that might make use of an API, or other object, software, firmware and/or hardware, suitable for communication with, processing for, or implementation of the column based encoding and query processing provided in accordance with various embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the column based encoding and query processing as described in various embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, i.e., roughly a set of instructions or tasks, that requests a service provided by another program or process. The client process utilizes the requested service without having to “know” any working details about the other program or the service itself.

In a client/server architecture, particularly a networked system, a client is usually a computer that accesses shared network resources provided by another computer, e.g., a server. In the illustration of FIG. 11, as a non-limiting example, computers 1120, 1122, 1124, 1126, 1128, etc. can be thought of as clients and computers 1110, 1112, etc. can be thought of as servers where servers 1110, 1112, etc. provide data services, such as receiving data from client computers 1120, 1122, 1124, 1126, 1128, etc., storing of data, processing of data, transmitting data to client computers 1120, 1122, 1124, 1126, 1128, etc., although any computer can be considered a client, a server, or both, depending on the circumstances. Any of these computing devices may be processing data, encoding data, querying data or requesting services or tasks that may implicate the column based encoding and query processing as described herein for one or more embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the column based encoding and query processing can be provided standalone, or distributed across multiple computing devices or objects.

In a network environment in which the communications network/bus 1140 is the Internet, for example, the servers 1110, 1112, etc. can be Web servers with which the clients 1120, 1122, 1124, 1126, 1128, etc. communicate via any of a number of known protocols, such as the hypertext transfer protocol (HTTP). Servers 1110, 1112, etc. may also serve as clients 1120, 1122, 1124, 1126, 1128, etc., as may be characteristic of a distributed computing environment.

### EXEMPLARY COMPUTING DEVICE

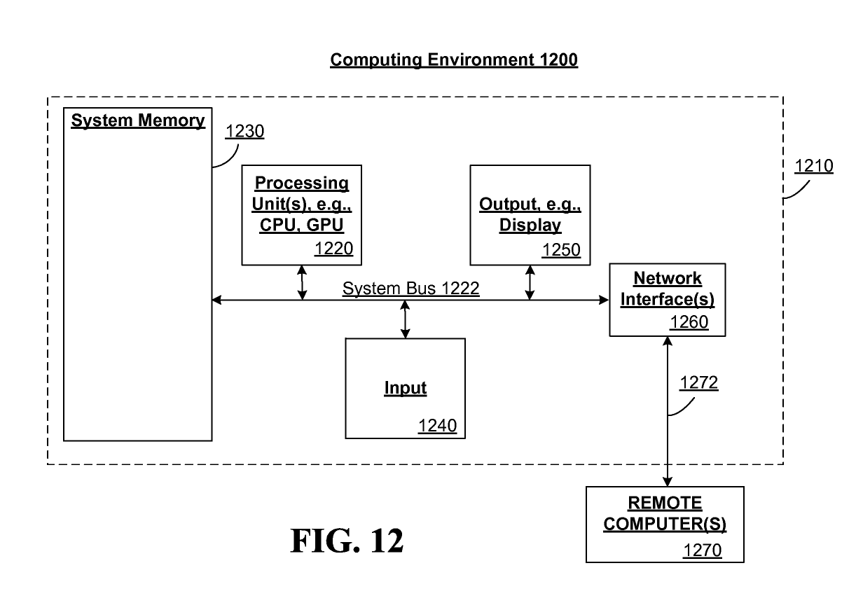

As mentioned, advantageously, the techniques described herein can be applied to any device where it is desirable to query large amounts of data quickly. It should be understood, therefore, that handheld, portable and other computing devices and computing objects of all kinds are contemplated for use in connection with the various embodiments, i.e., anywhere that a device may wish to scan or process huge amounts of data for fast and efficient results. Accordingly, the below general purpose remote computer described below in FIG. 12 is but one example of a computing device.

Although not required, embodiments can partly be implemented via an operating system, for use by a developer of services for a device or object, and/or included within application software that operates to perform one or more functional aspects of the various embodiments described herein. Software may be described in the general context of computer-executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol should be considered limiting.

FIG. 12 thus illustrates an example of a suitable computing system environment 1200 in which one or aspects of the embodiments described herein can be implemented, although as made clear above, the computing system environment 1200 is only one example of a suitable computing environment and is not intended to suggest any limitation as to scope of use or functionality. Neither should the computing environment 1200 be interpreted as having any dependency or requirement relating to any one or combination of components illustrated in the exemplary operating environment 1200.

With reference to FIG. 12, an exemplary remote device for implementing one or more embodiments includes a general purpose computing device in the form of a computer 1210. Components of computer 1210 may include, but are not limited to, a processing unit 1220, a system memory 1230, and a system bus 1222 that couples various system components including the system memory to the processing unit 1220.

Computer 1210 typically includes a variety of computer readable media and can be any available media that can be accessed by computer 1210. The system memory 1230 may include computer storage media in the form of volatile and/or nonvolatile memory such as read only memory (ROM) and/or random access memory (RAM). By way of example, and not limitation, memory 1230 may also include an operating system, application programs, other program modules, and program data.

A user can enter commands and information into the computer 1210 through input devices 1240. A monitor or other type of display device is also connected to the system bus 1222 via an interface, such as output interface 1250. In addition to a monitor, computers can also include other peripheral output devices such as speakers and a printer, which may be connected through output interface 1250.

The computer 1210 may operate in a networked or distributed environment using logical connections to one or more other remote computers, such as remote computer 1270. The remote computer 1270 may be a personal computer, a server, a router, a network PC, a peer device or other common network node, or any other remote media consumption or transmission device, and may include any or all of the elements described above relative to the computer 1210. The logical connections depicted in FIG. 12 include a network 1272, such local area network (LAN) or a wide area network (WAN), but may also include other networks/buses. Such networking environments are commonplace in homes, offices, enterprise-wide computer networks, intranets and the Internet.

As mentioned above, while exemplary embodiments have been described in connection with various computing devices and network architectures, the underlying concepts may be applied to any network system and any computing device or system in which it is desirable to compress large scale data or process queries over large scale data.

Also, there are multiple ways to implement the same or similar functionality, e.g., an appropriate API, tool kit, driver code, operating system, control, standalone or downloadable software object, etc. which enables applications and services to use the efficient encoding and querying techniques. Thus, embodiments herein are contemplated from the standpoint of an API (or other software object), as well as from a software or hardware object that provides column based encoding and/or query processing. Thus, various embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the described subject matter will be better appreciated with reference to the flowcharts of the various figures. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

In addition to the various embodiments described herein, it is to be understood that other similar embodiments can be used or modifications and additions can be made to the described embodiment(s) for performing the same or equivalent function of the corresponding embodiment(s) without deviating therefrom. Still further, multiple processing chips or multiple devices can share the performance of one or more functions described herein, and similarly, storage can be effected across a plurality of devices. Accordingly, the invention should not be limited to any single embodiment, but rather should be construed in breadth, spirit and scope in accordance with the appended claims.

What is claimed is:

1. A method for processing information embedded in a text file with a grammar programming language, including:
receiving a text file, the text file including a plurality of input values;
parsing each of the plurality of input values according to a set of rules;
compiling a script so as to produce a plurality of candidate textual shapes, each of the plurality of candidate textual shapes corresponding to a potential interpretation of the plurality of input values; and
providing an output, the output including at least one of:
a processed value, the processed value corresponding to a particular textual shape, the particular textual shape selected from the plurality of candidate textual shapes; or
a textual representation of the text file, the textual representation including a plurality of generic data structures that facilitate providing any of the plurality of candidate textual shapes, the generic data structures being a function of the set of rules.

2. The method of claim 1 further comprising identifying a syntactical ambiguity, the set of preferred rules providing a preference for resolving the syntactical ambiguity.

3. The method of claim 2, the compiling step further comprising analyzing the syntactical ambiguity according to at least a subset of the preferred rule and a plurality of alternative rules so as to compile a plurality of candidate syntactical resolutions, the output being a function of a prioritization of the plurality of candidate syntactical resolutions.

4. The method of claim 3, the prioritization including identifying a preferred syntactical resolution, the output being a function of the preferred syntactical resolution if the preferred syntactical resolution conforms with the at least a subset of the preferred rule, the output being a function of an alternative syntactical resolution selected from a remaining set of candidate syntactical resolutions if the preferred syntactical resolution does not conform with the at least a subset of the preferred rule, the alternative syntactical resolution selected as a function of the prioritizing step.

5. The method of claim 1 further comprising identifying a token ambiguity, the identifying step including matching each of a set of tokens representing all tokens included in the grammar programming language against a text value, the text value including a subset of the plurality of input values.

6. The method of claim 5, the matching step being performed sequentially on each of the subset of plurality of input values so as to generate a first set of remaining tokens, the method further comprising:
determining whether a first type of token ambiguity exists within the first set of remaining tokens, the first type of token ambiguity existing if the first set of remaining tokens includes at least two tokens;
resolving each of an existing first type of token ambiguity based on a match length so as to generate a second set of remaining tokens, the second set of remaining tokens being a subset of the first set of remaining tokens;
determining whether a second type of token ambiguity exists, the second type of token ambiguity existing where each of the second set of remaining tokens have the same match length; and
resolving each of an existing second type of token ambiguity by determining whether one of the second set of remaining tokens is a token marked final, the resolving step selecting the token marked final if present, the resolving step retaining each of the second set of remaining tokens and matching a new token against the text value starting with a first input value that has not already been matched if the token marked final is not present.

7. The method of claim 1, the parsing step further comprising parsing a first portion of the text file in a first lexical space and parsing a second portion of the text file in a second lexical space.

8. The method of claim 7 further comprising:
identifying a first syntactic marker, the first syntactic marker demarcating the beginning of a nested language;
transitioning to the second lexical space upon identifying the first syntactic marker;
parsing the nested language in the second lexical space;
identifying a second syntactic marker, the second syntactic marker demarcating the end of the nested language;
transitioning back to the first lexical space upon identifying the second syntactic marker; and
parsing a subsequent portion of the text file in the first lexical space, the subsequent portion of the text file immediately following the second syntactic marker.

9. The method of claim 1 further comprising providing a rule parameter, the providing step including:
defining a pattern with at least one argument;
calling the pattern, the calling step comprising substituting an arbitrary term for at least one of the at least one arguments; and
parsing the plurality of input values as a function of the arbitrary term.

10. The method of claim 1, the parsing step further comprising:
ascertaining a criteria for a set of checkpoint locations in the text file;
parsing the text file a single time for all locations matching the criteria;
tagging each of the locations matching the criteria as a checkpoint location; and
providing a map of the set of checkpoint locations, the map configured to allow a user to parse a portion of the text file, the portion of the text file either beginning or ending with a checkpoint location.

11. The method of claim 1 further comprising interleaving whitespace including:
identifying at least one token, each of the at least one tokens corresponding to a unique textual value;
defining an interleave whitespace rule;
parsing the text file for each of the at least one tokens, the parsing step interleaving a whitespace as a function of the interleave whitespace rule; and
returning a set of text values, the set of text values corresponding to each of the at least one tokens parsed out of the text file.

12. A computer-readable storage medium comprising instructions for facilitating processing information embedded in a text file with a grammar programming language, including:
a first module, the first module including instructions for receiving the text file as an input, the text file including a plurality of input values;
a second module, the second module including instructions for providing a library, the library including a plurality of constructs for interpreting a textual shape of the text file;
a third module, the third module including instructions for providing a script editor, the script editor configured to facilitate generating a script of the grammar programming language, the script including at least one of the plurality of constructs;
a fourth module, the fourth module including instructions for compiling the script as a function of the text file, the compiling instructions facilitating generating a plurality of candidate textual shapes, each of the plurality of candidate textual shapes corresponding to a potential interpretation of the plurality of input values; and
a fifth module, the fifth module including instructions for providing an output, the output including at least one of:
a processed value, the processed value corresponding to a particular textual shape, the particular textual shape selected from the plurality of candidate textual shapes; or
a textual representation of the text file, the textual representation including a plurality of generic data structures that facilitate providing any of the plurality of candidate textual shapes, the generic data structures being a function of the script.

13. The computer-readable storage medium of claim 12, the fourth module further comprising instructions for compiling a syntactical ambiguity into a plurality of candidate syntactical resolutions.

14. The computer-readable storage medium of claim 13, the fourth module further comprising instructions for compiling the syntactical ambiguity according to each of a preferred rule and at least one alternative rule, the output being a function of a prioritization of the plurality of candidate syntactical resolutions.

15. The computer-readable storage medium of claim 14, the fourth module further comprising instructions for identifying a preferred syntactical resolution, the output being a function of the preferred syntactical resolution if compilation of the preferred syntactical resolution yields one of the plurality of candidate textual shapes, the output being a function of an alternative syntactical resolution selected from a remaining set of candidate syntactical resolutions if the preferred syntactical resolution does not yield one of the plurality of candidate textual shapes, the alternative syntactical resolution selected as a function of the prioritization.

16. The computer-readable storage medium of claim 12, the fourth module further comprising instructions for identifying a token ambiguity, the identifying instructions including instructions for matching each of a set of tokens representing all tokens included in the grammar programming language against a text value, the text value including a subset of the plurality of input values.

17. The computer-readable storage medium of claim 16, the matching instructions including instructions for matching each of the set of tokens sequentially on each of the subset of plurality of input values so as to generate a first set of remaining tokens, the matching instructions further comprising instructions for:
determining whether a first type of token ambiguity exists within the first set of remaining tokens, the first type of token ambiguity existing if the first set of remaining tokens includes at least two tokens;
resolving each of an existing first type of token ambiguity based on a match length so as to generate a second set of remaining tokens, the second set of remaining tokens being a subset of the first set of remaining tokens;
determining whether a second type of token ambiguity exists, the second type of token ambiguity existing where each of the second set of remaining tokens have the same match length; and
resolving each of an existing second type of token ambiguity by determining whether one of the second set of remaining tokens is a token marked final, the resolving step selecting the token marked final if present, the resolving step retaining each of the second set of remaining tokens and matching a new token against the text value starting with a first input value that has not already been matched if the token marked final is not present.

18. The computer-readable storage medium of claim 12, the fourth module further comprising instructions for parsing a first portion of the text file in a first lexical space and parsing a second portion of the text file in a second lexical space.

19. The computer-readable storage medium of claim 18, the parsing instructions further comprising instructions for:
identifying a first syntactic marker, the first syntactic marker demarcating the beginning of a nested language;
transitioning to the second lexical space upon identifying the first syntactic marker;
parsing the nested language in the second lexical space;
identifying a second syntactic marker, the second syntactic marker demarcating the end of the nested language;
transitioning back to the first lexical space upon identifying the second syntactic marker; and
parsing a subsequent portion of the text file in the first lexical space, the subsequent portion of the text file immediately following the second syntactic marker.

20. The computer-readable storage medium of claim 12, the second module further comprising instructions for providing at least one construct that facilitates implementing a rule parameter, the providing instructions including instructions for:
defining a pattern with at least one argument;
calling the pattern, the calling step comprising substituting an arbitrary term for at least one of the at least one arguments; and
parsing the plurality of input values as a function of the arbitrary term.

21. The computer-readable storage medium of claim 12, the fourth module further comprising instructions for parsing the text file incrementally, the parsing instructions including instructions for:
ascertaining a criteria for a set of checkpoint locations in the text file;
parsing the text file a single time for all locations matching the criteria;
tagging each of the locations matching the criteria as a checkpoint location; and
providing a map of the set of checkpoint locations, the map configured to allow a user to parse a portion of the text file, the portion of the text file either beginning or ending with a checkpoint location.

22. The computer-readable storage medium of claim 12, the fourth module further comprising instructions for interleaving whitespace, the interleaving instructions including instructions for:
identifying at least one token, each of the at least one tokens corresponding to a unique textual value;
defining an interleave whitespace rule;
parsing the text file for each of the at least one tokens, the parsing step interleaving a whitespace as a function of the interleave whitespace rule; and
returning a set of text values, the set of text values corresponding to each of the at least one tokens parsed out of the text file.

23. A system executed by one or more processors for facilitating processing information embedded in a text file with a grammar programming language, including:
means for receiving a text file, the text file including a plurality of input values;
means for parsing each of the plurality of input values according to a set of rules;
means for identifying at least one syntactical ambiguity;
means for identifying at least one token ambiguity;
means for prioritizing a plurality of candidate textual shapes, the plurality of candidate textual shapes including at least one candidate resolution to the at least one syntactical ambiguity;
means for resolving the at least one token ambiguity;
means for compiling a script so as to produce the plurality of candidate textual shapes, each of the plurality of candidate textual shapes corresponding to a potential interpretation of the plurality of input values; and
means for providing an output, the output including at least one of:
a processed value, the processed value corresponding to a particular textual shape, the particular textual shape selected from the plurality of candidate textual shapes; or
a textual representation of the text file, the textual representation including a plurality of generic data structures that facilitate providing any of the plurality of candidate textual shapes, the generic data structures being a function of the set of rules.
